(19) United States
(12) Patent Application Publication
(10) Pub. No.: US 2014/0307197 A1
(43) Pub. Date: Oct. 16, 2014

(54) METHOD FOR MANUFACTURING DISPLAY APPARATUS, DISPLAY APPARATUS, AND MULTI-DISPLAY SYSTEM

(71) Applicant: Hiroyuki Moriwaki, Osaka-shi (JP)

(72) Inventor: Hiroyuki Moriwaki, Osaka-shi (JP)

(73) Assignee: SHARP KABUSHIKI KAISHA, Osaka-shi, Osaka (JP)

(21) Appl. No.: 14/113,676

(22) PCT Filed: Apr. 20, 2012
(86) PCT No.: PCT/JP2012/002765

§ 371 Date: Nov. 25, 2013

(30) Foreign Application Priority Data
Apr. 28, 2011 (JP) 2011-100626
Aug. 13, 2011 (JP) 2011-177349

(51) Int. Cl. G02F 1/1333; G02F 1/1335

(52) U.S. Cl. CPC G02F 1/13336; G02F 1/133524
USPC 349/58; 385/129; 445/24

(57) ABSTRACT

A method for manufacturing a display apparatus (100) includes a first step of arranging a display panel (110) inside a housing (130), and stacking, on a surface (110B) of the display panel (110), a cover member (142) such that part (140A) of the cover member (142) is fitted into a window (131W) and that the remaining part of the cover member (142) at least partially covers the part (140A) of the cover member (142) fitted into the window (131W) and an outer surface of a flange (130F); a second step of arranging, on an outer peripheral edge part of the cover member (142), a light guide member (150) with an adhesive (151) being interposed between the cover member (142) and the light guide member (150); and a third step of curing the adhesive (151) to bond the light guide member (150) to the cover member (142).

### TECHNICAL FIELD

The present disclosure relates to a method for manufacturing a display apparatus, to a display apparatus, and to a multi-display system. More specifically, the present disclosure relates to a method for manufacturing a display apparatus in which a light guide member is provided at a peripheral edge part of the display apparatus to form a multi-display system configured to display a seamless image, to a display apparatus forming a multi-display system configured to display a seamless image, and to a multi-display system configured to a seamless image.

### BACKGROUND ART

In recent years, for the purpose of use for, e.g., digital signage, emphasis has been placed on development of large-screen displays. In particular, increasing attention has been given to multi-display systems for each of which a large screen is formed in such a manner that a plurality of displays each including an extremely-narrow frame part are combined together.

In the case where a plurality of displays are combined together to form a large screen, it is preferred that a seam between adjacent ones of the displays is less noticeable. For such a reason, a frame-shaped light guide member such as a lens is arranged at a peripheral edge part of each display so that a seam between adjacent ones of the displays can be less noticeable (see, e.g., Patent Document 1).

### CITATION LIST

### Patent Document

PATENT DOCUMENT 1: Japanese Unexamined Patent Publication No. 2010-072522

### SUMMARY OF THE INVENTION

### Technical Problem

A method for bonding a light guide member 450 to a surface of a display panel 410 with an adhesive 451 such as ultraviolet curable resin or thermoset resin as illustrated in, e.g., FIG. 33 may be employed as a method for providing a frame-shaped light guide member at a peripheral edge part of a display. In this case, a spacer 431 is provided to prevent the adhesive 451 from dropping into a module. However, the adhesive 451 sometimes flows over the spacer 431, and a drop(s) 451A of the adhesive 451 drops into a housing 430 of a display apparatus. As a result, the drop(s) 451A of the adhesive 451 entering the module may flow around to the back of the display panel 410, or may adhere to a backlight (not shown in the figure) or a lens sheet (not shown in the figure). This may cause degradation of display properties such as spots in an image or lowering of brightness.

The present disclosure aims to attach a light guide member without dropping of an adhesive into a housing to form a display apparatus.

### Solution to the Problem

In order to accomplish the foregoing objective, a method for manufacturing a display apparatus according to the present disclosure includes a first step of arranging a display panel inside a housing which is formed with a window and which includes an inwardly-extending flange forming a window frame surrounding the window, and stacking, on a surface of the display panel, a cover member such that part of the cover member in a thickness direction thereof is fitted into the window and that the remaining part of the cover member in the thickness direction thereof at least partially covers the part of the cover member fitted into the window and an outer surface of the flange; a second step of arranging, on part of a surface of the cover member corresponding to an outer peripheral edge part of the housing, a light guide member configured to guide light from the display panel to an outside of the display panel with an adhesive being interposed between the cover member and the light guide member; and a third step of curing the adhesive to bond the light guide member to the cover member.

According to the foregoing method, since the cover member is, at the first step, arranged such that the remaining part of the cover member at least partially covers the outer surface of the flange, the adhesive does not drop into the housing even if the adhesive spreads, at the second step, due to the light guide member arranged on the surface of the cover member with the adhesive being interposed between the cover member and the light guide member.

In the foregoing method, at the first step, the cover member is preferably a protrusion-equipped cover member further including a protrusion protruding outward. Moreover, after the third step, a fourth step of cutting the protrusion off from the protrusion-equipped cover member is preferably performed.

According to the foregoing method, the protrusion-equipped cover member including the protrusion protruding outward is stacked on the surface of the display panel at the first step. Thus, even if the adhesive spreads, at the second step, due to the light guide member arranged on the peripheral edge part of the protrusion-equipped cover member with the adhesive being interposed between the protrusion-equipped cover member and the light guide member, fouling of the housing or the periphery thereof with the adhesive adhered or splattered on the housing upon dropping from the protrusion of the protrusion-equipped cover member to the outside of the housing is reduced. The length of the protrusion from the light guide member is preferably equal to or greater than 5 cm.

The length of the protrusion may be equal to or less than 5 cm or equal to or greater than 5 cm. If the length of the protrusion is equal to or less than 5 cm, the amount of the protrusion to be cut off at the fourth step is reduced, and therefore a cost can be decreased by such an amount. In this case, a gutter-shaped adhesive receiver configured to receive the adhesive dropping from a peripheral edge part of the protrusion is preferably placed. This reduces fouling of an outer part of the housing or the periphery thereof with the adhesive splattered upon dropping from the peripheral edge part of the protrusion.

If the length of the protrusion is equal to or greater than 5 cm, dropping of the adhesive from the peripheral edge part of the protrusion is reduced even if the light guide member is arranged on the protrusion. Thus, fouling of the outer part of the housing or the periphery thereof with the adhesive can be reduced or prevented without providing the adhesive receiver.

In the foregoing method, the cover member may be configured such that a first cover member fitted into the window and a second cover member at least partially covering the first cover member and the outer surface of the flange are stacked on each other.

Alternatively, in the foregoing method, the cover member may be integrally formed of a first cover part fitted into the window and a second cover part at least partially covering the first cover part and the outer surface of the flange.

In the foregoing method, at the first step, the cover member may be stacked so as to cover at least an entire display region of the display panel.

Alternatively, in the foregoing method, at the first step, the cover member may be in a frame shape and may be stacked so as to cover a peripheral edge part of the surface of the display panel.

In the foregoing method, if the cover member includes the protrusion, at the fourth step, the protrusion may be cut off from the protrusion-equipped cover member such that a peripheral end surface of the cover member is flush with at least one of an outer surface of the housing or an outer peripheral end surface of the light guide member.

According to the foregoing method, since the protrusion may be cut off such that the peripheral end surface of the cover member is flush with at least one of the outer surface of the housing or the outer peripheral end surface of the light guide member, cutting is facilitated.

In such a case, the light guide member may be arranged on the adhesive such that the outer peripheral end surface of the light guide member is flush with the outer surface of the housing. All of the peripheral end surface of the cover member, the outer surface of the housing, and the outer peripheral end surface of the light guide member are flush with each other. Thus, when a plurality of display apparatuses are combined together and are used as a multi-display system, the display apparatuses can be combined together such that a clearance is not formed between the light guide member and the housing. Consequently, stress on the light guide member upon assembly of a large-screen display can be reduced.

In the foregoing method, if the cover member is a protrusion-equipped cover member which is configured such that the first cover member fitted into the window and the second cover member at least partially covering the first cover member and the outer surface of the flange are stacked on each other, the second cover member preferably further includes an inner protrusion protruding toward an inside of the display panel, and, after the third step, a fifth step of cutting the inner protrusion off from the protrusion-equipped cover member is preferably performed independently of the fourth step.

According to the foregoing method, since the inner protrusion is provided, there is no possibility that the adhesive drops onto the display panel even if the adhesive applied onto the second cover member spreads toward the inside of the display panel at the second step.

In such a case, at the second step, the light guide member is arranged such that an inner peripheral end surface of the light guide member is flush with an inner peripheral end surface of the first cover member. Moreover, at the fifth step, the inner protrusion is cut off such that an inner peripheral end surface of the second cover member is flush with the inner peripheral end surface of the first cover member and the inner peripheral end surface of the light guide member.

According to the foregoing, since a clearance corresponding to the thickness of the first cover member is formed between the second cover member and the display panel, the inner protrusion can be cut of without damaging the surface of the display panel when the inner protrusion is cut off relative to the inner peripheral end surface of the first cover member at the fifth step.

The cover member may be made of acrylic resin. In such a case, the cover member has excellent chemical resistance and excellent abrasion resistance. Moreover, since a difference between the refractive index (1.49) of acrylic resin and the refractive index (about 1.5) of glass forming the display panel or the refractive index (about 1.5) of a polarizing plate is small, light refraction at an interface between the display panel and the cover member can be reduced, and therefore excellent image visibility can be realized.

If the cover member is configured such that the first and second cover members are stacked on each other, the first cover member is preferably made of a transparent elastic material. Examples of the transparent elastic material include an acrylic gel sheet, a silicone rubber sheet, and a polyurethane gel sheet.

In such a case, since the transparent elastic material has viscosity, the first cover member can be stacked on the display panel without using the adhesive, and the second cover member can be stacked on the first cover member without using the adhesive. Moreover, since the transparent elastic material itself has moderate viscosity, excellent re-workability of the first cover member is realized. Since the transparent elastic material has flexibility and elasticity, the first cover member can be bonded with reduction in air bubbles etc. entering between the display panel and the first cover member even if the thickness of the transparent elastic material is large. Moreover, due to the elasticity of the transparent elastic material, stress applied between the display panel and a light guide lens is absorbed, and therefore panel strength can be enhanced.

In the foregoing method, if the cover member is configured such that the first and second cover members are stacked on each other, the second cover member may be made of polyethylene terephthalate resin or triacetylcellulose resin. The PET resin or the TAC resin forming the second cover member has a thickness of, e.g., 10-100 μm.

In such a case, since the second cover member has flexibility, the second cover member is easily bonded, and entering of air bubbles etc. between the first and second cover members is reduced. If the second cover member includes the protrusion or the inner protrusion, the protrusion or the inner protrusion is also made of the PET resin or the TAC resin as in the second cover member. Thus, at the fourth or fifth step, the protrusion or the inner protrusion can be easily cut off. Further, the second cover member made of the PET resin has advantages such as high chemical resistance and a low material cost. If the second cover member is made of the TAC resin, the refractive index of the TAC resin is 1.48, and therefore an optical phase difference from the light guide member (having a refractive index of about 1.49) is small. Thus, good visibility can be realized.

Alternatively, the second cover member may be made of a transparent elastic material. Example of the transparent elastic material include an acrylic gel sheet, a silicone rubber sheet, and a polyurethane gel sheet.

In such a case, since the second cover member has flexibility, the second cover member is easily bonded, and entering of air bubbles etc. between the first and second cover members is reduced. If the second cover member includes the protrusion or the inner protrusion, the protrusion or the inner protrusion is also made of the transparent elastic material as in the second cover member. Thus, at the fourth or fifth step, the protrusion or the inner protrusion can be easily cut off. Moreover, due to viscosity of the transparent elastic material, dripping of the adhesive applied onto the second cover member is less likely to occur. Further, due to elasticity of the transparent elastic material, stress applied between the display panel and the light guide lens is absorbed, and therefore the panel strength can be enhanced.

The second cover member may be made of acrylic resin. In such a case, the second cover member having excellent chemical resistance and excellent abrasion resistance can be realized.

In the foregoing method, the display panel is suitable for the case where the length of a diagonal line is equal to or greater than 812 mm.

In the foregoing method, the display panel is suitable for the case where the display panel is a liquid crystal display panel in which a liquid crystal layer is provided between two substrates.

A display apparatus of the present disclosure includes a display panel; a housing which contains the display panel, which is formed with a window, and which includes an inwardly-extending flange forming a window frame surrounding the window; a transparent cover member stacked on a surface of the display panel such that part of the cover member in a thickness direction thereof is fitted into the window and that the remaining part of the cover member in the thickness direction thereof at least partially covers the part of the cover member fitted into the window and an outer surface of the flange; and a frame-shaped light guide member bonded to an outer peripheral edge part of the cover member with an adhesive and configured to guide light from the display panel to an outside of the display panel.

According to the foregoing configuration, the cover member stacked on the surface of the display panel is provided such that the part of the cover member in the thickness direction thereof is fitted into the window and that the remaining part of the cover member in the thickness direction thereof at least partially covers the part of the cover member fitted into the window and the outer surface of the flange. Thus, even if the light guide member is bonded to the cover member with the adhesive, the adhesive does not drop into the housing. Thus, spots in an image, lowering of brightness, etc. due to flow of the adhesive around to the back of the display panel in the housing or adherence of the adhesive to a backlight, a lens sheet, etc. can be reduced or prevented.

In the foregoing display apparatus, the cover member may be configured such that a first cover member fitted into the window and a second cover member at least partially covering the first cover member and the outer surface of the flange are stacked on each other.

Alternatively, in the foregoing display apparatus, the cover member may be integrally formed of a first cover part fitted into the window and a second cover part at least partially covering the first cover part and the outer surface of the flange.

In the foregoing display apparatus, the cover member may be bonded so as to cover at least an entire display region of the display panel.

Alternatively, in the foregoing display apparatus, the cover member may be in a frame shape and may be bonded so as to cover a peripheral edge part of the surface of the display panel.

A peripheral end surface of the cover member is preferably flush with at least one of an outer peripheral end surface of the light guide member or an outer surface of the housing.

In such a case, the light guide member may be configured such that the outer peripheral end surface of the light guide member and the outer surface of the housing are flush with each other. In this case, all of the outer peripheral end surface of the light guide member, the peripheral end surface of the cover member, and the outer surface of the housing are flush with each other. Thus, when a plurality of display apparatuses are combined together and are used as a multi-display system, the display apparatuses can be combined together such that a clearance is not formed between the light guide member and the housing. Consequently, stress on the light guide member upon assembly of a large-screen display can be reduced.

In the foregoing display apparatus, if the cover member is configured such that the first cover member fitted into the window and the second cover member at least partially covering the first cover member and the outer surface of the flange are stacked on each other, an inner peripheral end surface of the second cover member is preferably flush with at least one of an inner peripheral end surface of the first cover member or an inner peripheral end surface of the light guide member.

In the foregoing display apparatus, the cover member may be made of acrylic resin.

In the foregoing display apparatus, if the cover member is configured such that the first and second cover members are stacked on each other, the first cover member may be made of a transparent elastic material.

In the foregoing display apparatus, if the cover member is configured such that the first and second cover members are stacked on each other, the second cover member may be made of polyethylene terephthalate resin or triacetylcellulose resin. Alternatively, the second cover member may be made of a transparent elastic material. As still another alternative, the second cover member may be made of acrylic resin.

In the foregoing display apparatus, if the cover member is configured such that the first and second cover members are stacked on each other, the first cover member may be formed of a touch panel sheet.

The foregoing display apparatus is suitable for the case where the length of a diagonal line is equal to or greater than 812 mm.

In the foregoing display apparatus, the display panel is suitable for the case where the display panel is a liquid crystal display panel in which a liquid crystal layer is provided between two substrates.

A multi-display system of the present disclosure is configured to display an image on a large screen formed by combining a plurality of display apparatuses of the present disclosure. In the display apparatus of the present disclosure, a light guide member configured to guide light from a display panel to the outside of the display panel is provided at a peripheral edge part of the display panel. Thus, even if such display apparatuses are combined together such that each enlarged portion of an image is displayed on a corresponding one of the display apparatuses, seams are less noticeable, and therefore good display of an image can be provided.

### Advantages of the Invention

According to the present disclosure, since the cover member is, at the first step, arranged such that the remaining part of the cover member in the thickness direction thereof at least partially covers the outer surface of the flange, the adhesive does not drop into the housing even if the adhesive spreads, at the second step, due to the light guide member arranged on the cover member with the adhesive being interposed between the light guide member and the cover member. Thus, spots in an image, lowering of brightness, etc. due to flow of the adhesive around to the back of the display panel in the housing or adherence of the adhesive to the backlight, the lens sheet, etc. can be reduced or prevented.

### BRIEF DESCRIPTION OF THE DRAWINGS

FIG. 1 is a schematic diagram of an entire configuration of a multi-display system.

FIG. 2 is a diagram illustrating the state in which displays of the multi-display system are assembled together.

FIG. 3 is a cross-sectional view of a display apparatus of a first embodiment.

FIG. 4 is a schematic plan view of the display apparatus of the first embodiment.

FIG. 5 is a cross-sectional view of a display panel.

FIG. 6 is a flowchart illustrating a step of bonding the display apparatus of the first embodiment.

FIG. 7 is a view illustrating a first step in a method for manufacturing the display apparatus of the first embodiment.

FIG. 8 is a view illustrating a second step in the method for manufacturing the display apparatus of the first embodiment.

FIG. 9 is a view illustrating a third step in the method for manufacturing the display apparatus of the first embodiment.

FIG. 10 is a view illustrating a fourth step in the method for manufacturing the display apparatus of the first embodiment.

FIG. 11 is a schematic cross-sectional view of a display apparatus of a first variation.

FIG. 12 is a schematic plan view of the display apparatus of the first variation.

FIG. 13 is a schematic cross-sectional view of a display apparatus of a second variation.

FIG. 14 is a schematic plan view of the display apparatus of the second variation.

FIG. 15 is a schematic cross-sectional view of a display apparatus of a third variation.

FIG. 16 is a view illustrating a second step in a method for manufacturing a display apparatus of a fourth variation.

FIG. 17 is a schematic cross-sectional view of a display apparatus of a fifth variation.

FIG. 18 is a cross-sectional view of a display apparatus of a second embodiment.

FIG. 19 is a flowchart illustrating a step of bonding the display apparatus of the second embodiment.

FIG. 20 is a view illustrating a step of bonding a light guide member according to the second embodiment.

FIG. 21 is a cross-sectional view of a display apparatus of a third embodiment.

FIG. 22 is a plan view of a display apparatus of a sixth variation.

FIG. 23 is a cross-sectional view of two display apparatuses of the sixth variation arranged adjacent to each other.

FIG. 24 is a flowchart illustrating a step of bonding the display apparatus of the third embodiment.

FIG. 25 is a view illustrating a first step in a method for manufacturing the display apparatus of the third embodiment.

FIG. 26 is another view illustrating the first step in the method for manufacturing the display apparatus of the third embodiment.

FIG. 27 is a view illustrating a second step in the method for manufacturing the display apparatus of the third embodiment.

FIG. 28 is a view illustrating second and third steps in the method for manufacturing the display apparatus of the third embodiment.

FIG. 29 is a view illustrating fourth and fifth steps in the method for manufacturing the display apparatus of the third embodiment.

FIG. 30 is a view illustrating the state in which bonding of a light guide member is completed in the method for manufacturing the display apparatus of the third embodiment.

FIG. 31 is a view illustrating fourth and fifth steps in a method for manufacturing a display apparatus of a seventh variation.

FIG. 32 is a cross-sectional view of the display apparatus of the seventh variation.

FIG. 33 is a view illustrating a step of attaching a light guide member of a conventional display apparatus.

### DESCRIPTION OF EMBODIMENTS

Example embodiments of the present disclosure will be described below. Note that the present disclosure is not limited to the embodiments described below. Moreover, the same reference numerals are used to represent identical or equivalent elements in drawings.

### First Embodiment

### Multi-Display System

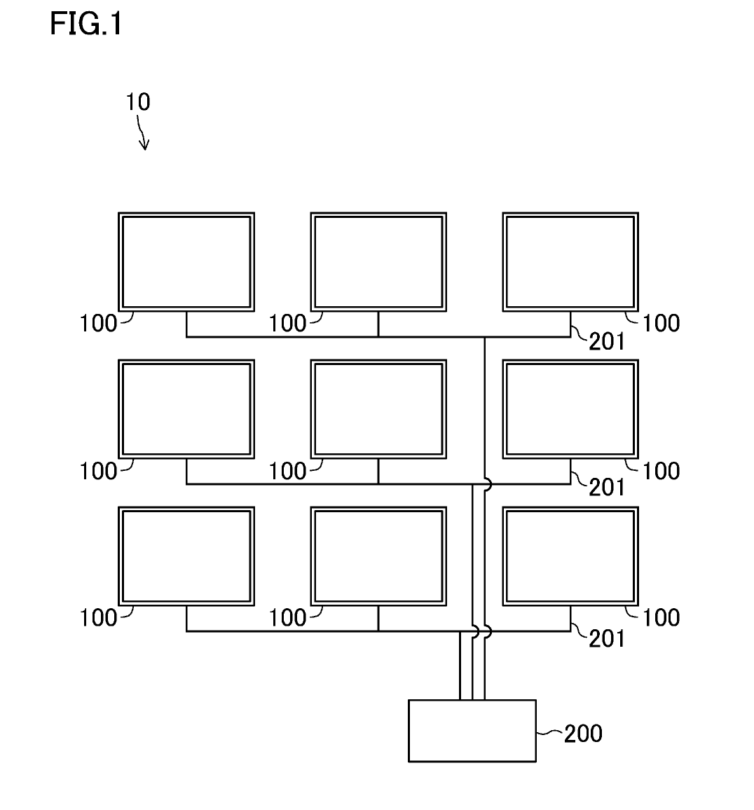

FIG. 1 is a schematic diagram of a multi-display system 10. The multi-display system 10 is used for, e.g., digital signage configured to display an image at a large screen.

The multi-display system 10 includes a plurality of display apparatuses 100 (nine display apparatuses 100 in FIG. 1) and a manager 200. The manager 200 communicates with each display apparatus 100 via a network 201. The manager 200 has functions to transmit contents to be displayed at each display apparatus 100 and to switch a display mode of each display apparatus 100. Note that the display apparatuses 100 may be connected together in parallel to each other as illustrated in FIG. 1, or may be connected together in series with each other via a general purpose interface bus (GPIB) interface board.

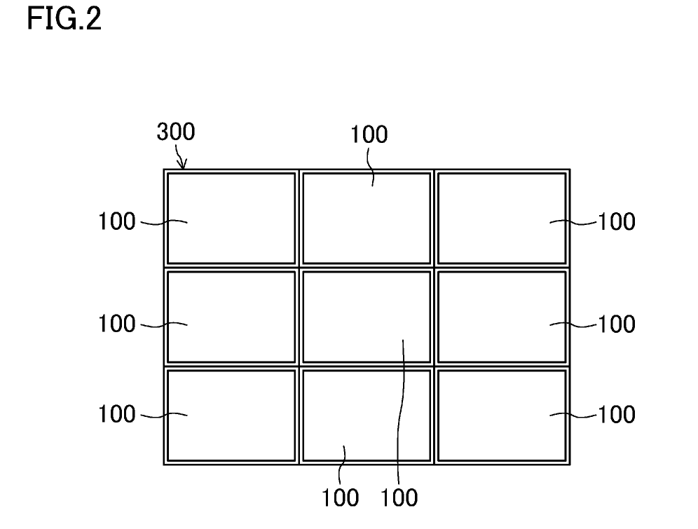

FIG. 2 illustrates the state in which the display apparatuses 100 are assembled together. The display apparatuses 100 forms a large-screen display 300. Each display apparatus 100 may display, based on a command from the manager 200, a corresponding one of enlarged portions of a single image so that the single image can be displayed across the large-screen display 300. Alternatively, the same image may be displayed on the display apparatuses 100 without image enlargement (i.e., nine images are displayed in a matrix). As still another alternative, different images may be displayed on the display apparatuses 100.

(Display Apparatus)

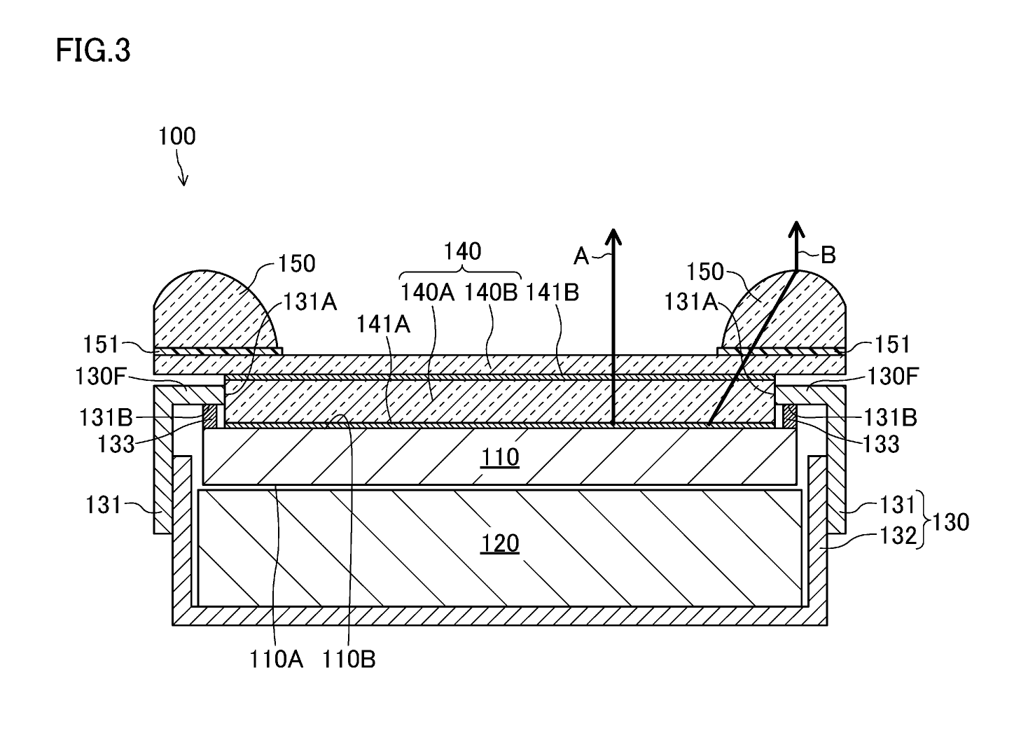

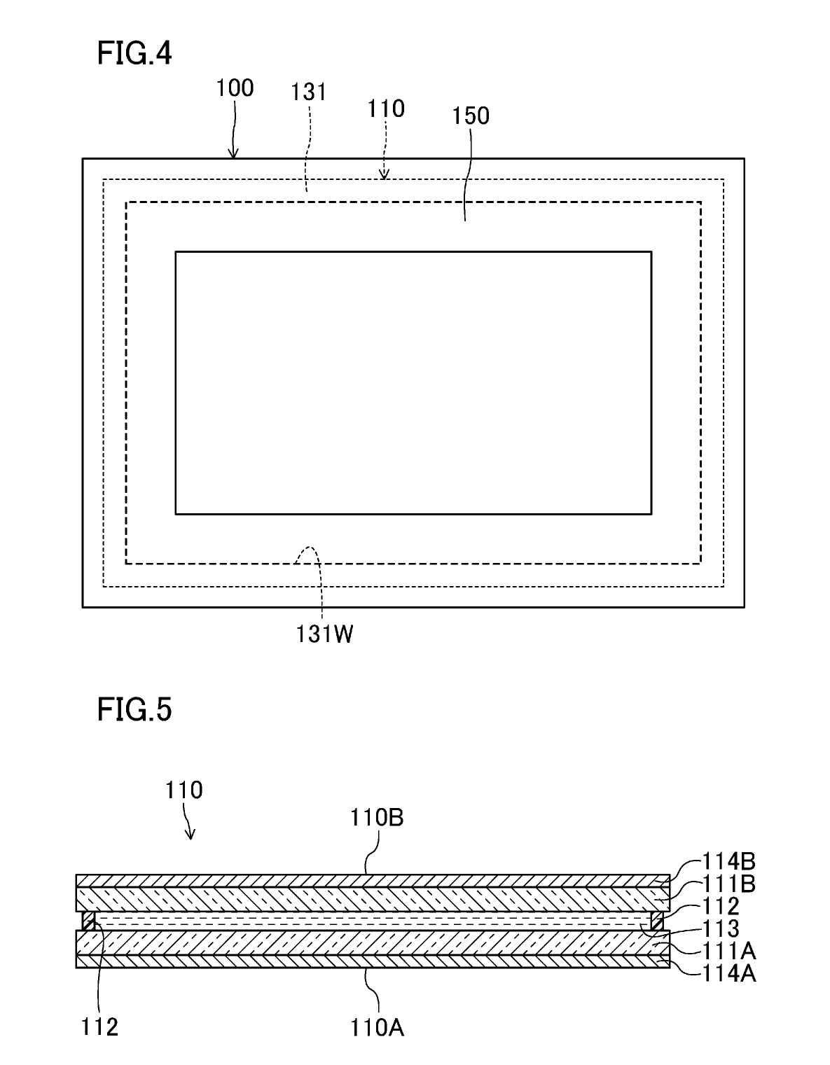

FIG. 3 is a cross-sectional view of the display apparatus 100, and FIG. 4 is a schematic plan view of the display apparatus 100. The display apparatus 100 includes a display panel 110 configured to display an image, a backlight unit 120 configured to output light to the display panel 110, a housing 130 containing the display panel 110 and the backlight unit 120, first and second sheets (first and second cover members) 140A, 140B (hereinafter sometimes collectively referred to as a “cover member 140”) configured to cover and protect a surface of the display panel 110 on an image display side 110B, and a light guide member 150 provided corresponding to a peripheral edge part of the display panel 110.

Referring to FIG. 5, the display panel 110 includes two substrates 111A, 111B arranged so as to face each other, a sealing material 112 provided in a frame shape between the substrates 111A, 111B at the peripheral edge part of the display panel 110 and configured to bond the substrates 111A, 111B together, a liquid crystal layer 113 provided in a region surrounded by the sealing material 112, and polarizing plates 114A, 114B provided respectively on surfaces of the substrates 111A, 111B opposite to the liquid crystal layer 113. Note that the substrate 111A and the polarizing plate 114A are arranged on a backlight unit side 110A of the display panel 110, and the substrate 111B and the polarizing plate 114B are arranged on the image display side 110B of the display panel 110. The display panel 110 preferably has a diagonal line length of equal to or greater than 812 mm (32-inch size), and more preferably about 60-inch size, i.e., a vertical length of 747 mm and a horizontal length of 1328 mm.

The backlight unit 120 is arranged so as to face a surface of the display panel 110 on a side close to the polarizing plate 114A. Although not shown in the figure, the backlight unit 120 includes, e.g., a light source such as a cold cathode fluorescent tube or a light emitting diode (LED), a light guide plate configured to guide light from the light source to the display panel 110, and a diffuser plate. When passing through the liquid crystal layer 113 via the substrate 111A, the transmittance of light guided by the light guide plate and entering the display panel 110 is adjusted according to an alignment direction of liquid crystal molecules. Then, the light is output from the substrate 111B on the image display side, thereby displaying an image.

The housing 130 includes, e.g., a front housing part 131 containing the display panel 110, and a back housing part 132 supporting the backlight unit 120.

A window 131W is formed at a bottom part of the front housing part 131, and a flange 130F forming a window frame of the window 131W is provided so as to extend inward. The display panel 110 and part of the first sheet 140A in a thickness direction thereof are arranged inside the front housing part 131. The display panel 110 is positioned inside the front housing part 131 such that a displayed image can be viewed from the outside through the window 131W. A frame-shaped spacer 133 is formed along the peripheral edge part of the display panel 110 on a surface of the polarizing plate 114B of the display panel 110. The front housing part 131 is fixed to the first sheet 140A in the state in which a surface 131A forming the window 131W contacts a side surface of the first sheet 140A. Moreover, an inner surface 131B of the flange 130F contacts a tip end of the spacer 133, and therefore the display panel 110 and the front housing part 131 are fixed together.

The back housing part 132 is in a rectangular box shape with a closed bottom, and the backlight unit 120 is arranged inside the back housing part 132. A bottom surface of the backlight unit 120 is fixed to a bottom surface of the back housing part 132, and therefore the backlight unit 120 is supported by the back housing part 132. Moreover, an inner side wall surface of the front housing part 131 contacts an outer side wall surface of the back housing part 132, and therefore the front housing part 131 and the back housing part 132 are supported against each other.

The frame-shaped spacer 133 is interposed between the inner surface 131B of the flange 130F and the peripheral edge part of the display panel 110 so that the flange 130F and the display panel 110 are fixed together. The spacer 133 is made of, e.g., silicone rubber (commercialized products such as a silicone rubber adhesive tape manufactured by Teraoka Seisakusho Co., Ltd.). The spacer 133 has a height of, e.g., 0.1-0.2 mm.

The cover member 140 includes the first sheet 140A and the second sheet 140B. The first sheet 140A is bonded to the display panel 110 with a double-sided tape 141A, and the second sheet 140B is bonded to the first sheet 140A with a double-sided tape 141B.

The first sheet 140A is bonded to the surface of the display panel 110 on the image display side 110B so as to cover the entirety of a display region of the display panel 110. The first sheet 140A is formed in size corresponding to the window 131W of the front housing part 131, and is fitted into the window 131W. The first sheet 140A has a thickness of, e.g., 0.1-1 mm.

The second sheet 140B is provided so as to cover the entirety of a surface of the first sheet 140A opposite to the display panel 110. Moreover, the second sheet 140B is formed so as to be slightly larger than the first sheet 140A, and an outer peripheral edge part of the second sheet 140B covers an outer surface of the flange 130F. The second sheet 140B has a thickness of, e.g., 0.01-0.5 mm.

The first and second sheets 140A, 140B and the double-sided tapes 141A, 141B preferably have a refractive index of 1.3-1.7, and more preferably a refractive index of close to 1.5. The refractive index of glass forming the display panel 110 and the refractive index of the polarizing plate 114B are about 1.5. The first and second sheets 140A, 140B and the double-sided tapes 141A, 141B are made of a material having a refractive index close to such a value to suppress light refraction at, e.g., an interface between the display panel 110 and the double-sided tape 141A, an interface between the double-sided tape 141A and the first sheet 140A, an interface between the first sheet 140A and the double-sided tape 141B, and an interface between the double-sided tape 141B and the second sheet 140B. Examples of the material of the first and second sheets 140A, 140B include acrylic resin (having a refractive index of 1.5). In terms of chemical resistance and abrasion resistance, acrylic resin is also suitable as the material of the first and second sheets 140A, 140B. Moreover, examples of the material of the double-sided tapes 141A, 141B include a tape (having a refractive index of about 1.5) made of an acrylic-based resin material. Specifically, e.g., an optical clear adhesive (OCA) tape and an acrylic gel sheet can be used as the double-sided tapes 141A, 141B. For example, commercialized products such as high-transparency adhesive transfer tapes manufactured by Sumitomo 3M Ltd. can be used as the OCA tape. Moreover, e.g., bunshikoubaimaku super adhesive force double coated tapes (trademark registered by Kyodo Giken Chemical Co., Ltd.) can be used as the acrylic gel sheet. For example, commercialized products such as “300Z series” manufactured by Kyodo Giken Chemical Co., Ltd. can be used.

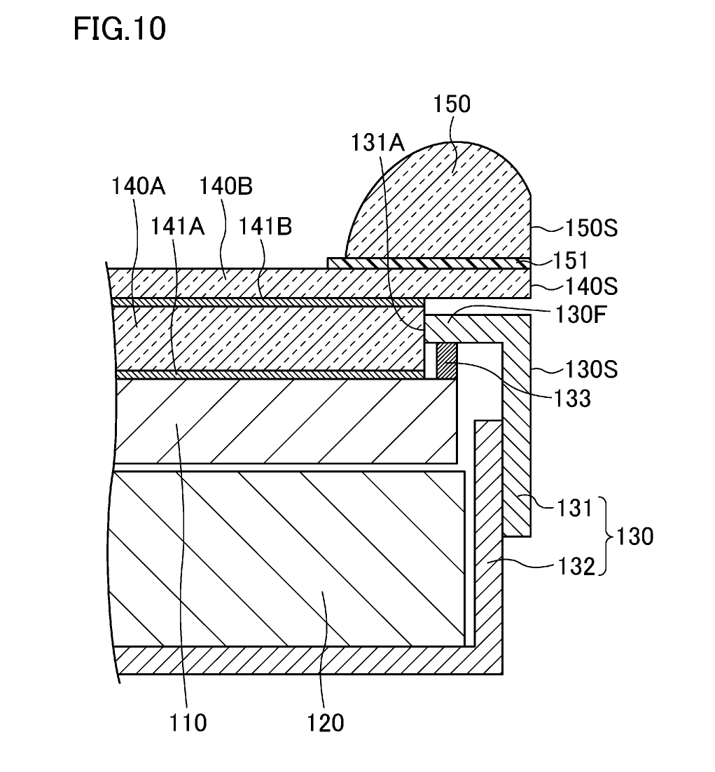

The light guide member 150 having a frame shape is provided at a peripheral edge part of the second sheet 140B on a surface thereof opposite to the first sheet 140A. As viewed in the cross section illustrated in FIG. 3, the light guide member 150 is in, e.g., a shape formed of a straight line contained in a plane facing the second sheet 140B, a straight line defining a peripheral end surface 1505 (see FIG. 10) of the light guide member 150, and a curved line defining a curved surface which connects the foregoing two straight lines and which protrudes toward the image display side. The light guide member 150 is made of, e.g., a transparent insulating material such as acrylic resin. The light guide member 150 has a width of, e.g., 10-100 mm and a thickness of, e.g., 10-30 mm.

In a region of the display panel 110 where no light guide member 150 is provided, light output from the display panel 110 configured to display an image is, on average, output perpendicular to the display panel 110 as indicated by an arrow A illustrated in FIG. 3. On the other hand, since the light guide member 150 is provided at the peripheral edge part of the display panel 110 on the image display side, light is, as indicated by an arrow B illustrated in FIG. 3, refracted at the curved surface of the light guide member 150 in the peripheral edge part of the display panel 110 when passing through the light guide member 150, and then the light travels toward the outside of the display panel 110. Thus, in the case where the plurality of display apparatuses 100 are used to form the multi-display system 10 including the large-screen display 300, and each enlarged portion of an image is displayed on a corresponding one of the display apparatuses 100, light output from the display panel 110 through the peripheral edge part thereof is guided to the outside of the display panel 110. Thus, images can be easily viewed at a seam between adjacent ones of the display apparatuses 100, and therefore the seam becomes less noticeable.

The light guide member 150 is bonded to a surface of the second sheet 140B with an adhesive 151. Examples of the adhesive 151 include ultraviolet curable resin and thermoset resin.

An outer surface 130S of the front housing part 131, a peripheral end surface 140S of the second sheet 140B, and the outer peripheral end surface 150S of the light guide member 150 (see FIG. 10 for each surface) are positioned so as to be flush with each other. Thus, when the plurality of display apparatuses 100 are combined together to form the large-screen display 300, the display apparatuses 100 can be combined together such that no clearance is formed between the light guide member and the housing. Consequently, stress on the light guide member when the display apparatuses 100 are assembled into the large-screen display can be reduced.

(Method for Manufacturing Display Apparatus)

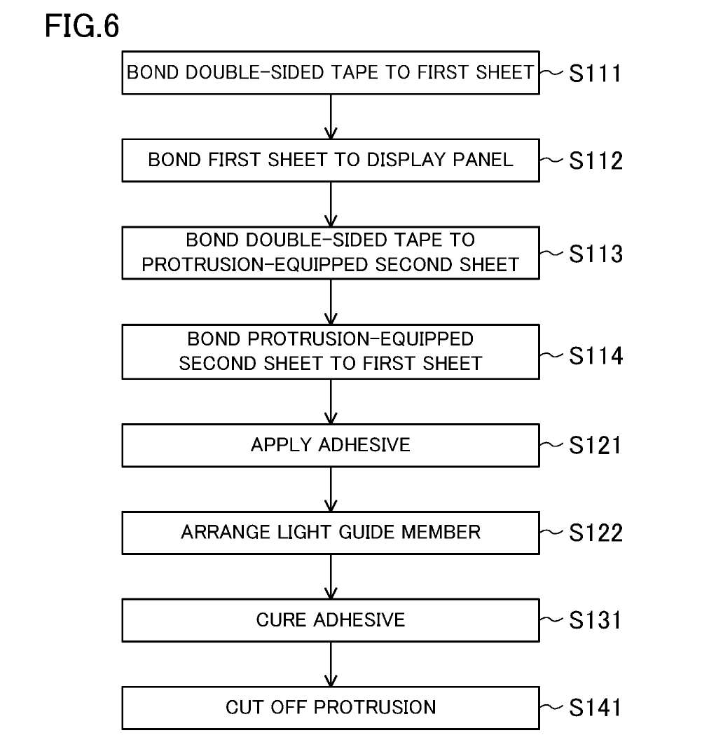

Next, a method for manufacturing the display apparatus 100 having the foregoing configuration will be described. Each of a preparation step, a first step, a second step, a third step, and a fourth step will be described herein in detail with reference to a flowchart illustrated in FIG. 6.

Preparation Step

First, a display panel 110, a backlight unit 120, a front housing part 131, a back housing part 132, a first sheet 140A, a protrusion-equipped second sheet 142, and a light guide member 150 are prepared. Note that the display panel 110 is formed in a conventionally-known method.

The protrusion-equipped second sheet 142 is made of a material, such as an acrylic resin sheet, having an area slightly larger than that of a sheet material to be a second sheet 140B. In an outer peripheral edge part of the protrusion-equipped second sheet 142, part (i.e., part of the protrusion-equipped second sheet 142 outwardly protruding beyond an outer surface 130S of a housing 130) of the protrusion-equipped second sheet 142 which outwardly protrudes beyond part of the protrusion-equipped second sheet 142 to be the second sheet 140B forms a protrusion 142a. The protrusion-equipped second sheet 142 is formed such that the length of the protrusion from the part of the protrusion-equipped second sheet 142 to be the second sheet 140B is, e.g., 100 μm to 1 mm.

A cover film 152 is pre-bonded to a surface of the protrusion-equipped second sheet 142 opposite to the first sheet 140A. The cover film 152 is positioned in a region surrounded by a region where the light guide member 150 is arranged. For example, a film made of polyethylene terephthalate (PET) or triacetylcellulose (TAC) may be used as the cover film 152.

Note that part of the cover film 152 in the region where the light guide member 150 is arranged may be removed after the cover film 152 is bonded to the entire surface of the protrusion-equipped second sheet 142. Alternatively, the cover film 152 pre-cut into a shape corresponding to an inner region relative to the region where the light guide member 150 is arranged may be bonded to a corresponding part of the protrusion-equipped second sheet 142.

First Step

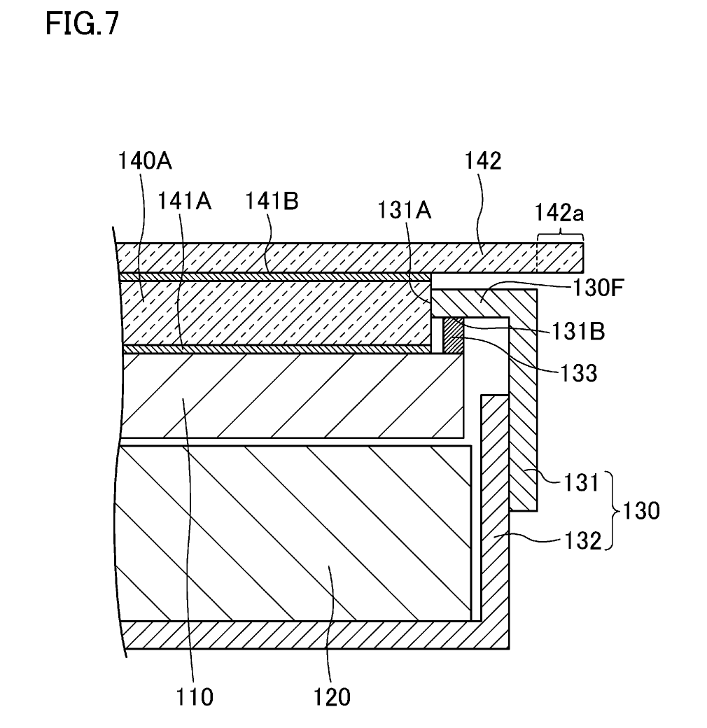

First, the backlight unit 120 is fixed to the back housing part 132. Then, referring to FIG. 7, a frame-shaped spacer 133 is arranged on a surface of a peripheral edge part of the display panel 110 on an image display side 110B or on an inner surface of a flange 130F of the front housing part 131, and the front housing part 131 and the display panel 110 are fixed together at the inner surface of the flange 130F of the front housing part 131 and the surface of the peripheral edge part of the display panel 110 on the image display side 110B. Next, the front housing part 131 and the back housing part 132 are assembled together by, e.g., screw tightening such that an inner side wall surface of the front housing part 131 and an outer side wall surface of the back housing part 132 are supported against each other in contact with each other. Thus, the display panel 110 and the backlight unit 120 are accommodated in the housing 130.

Next, a double-sided tape 141A is bonded to a surface of the first sheet 140A close to the display panel 110 at step S111. At step S112, the first sheet 140A is bonded so as to cover a display region of the display panel 110 with the double-sided tape 141A being interposed between the first sheet 140A and the display panel 110. In such a state, the first sheet 140A is positioned inside a window 131W of the front housing part 131.

Subsequently, a double-sided tape 141B is bonded to a surface of the protrusion-equipped second sheet 142 close to the first sheet 140A at step S113. At step S114, the protrusion-equipped second sheet 142 is bonded so as to cover a surface of the first sheet 140A opposite to the display panel 110 with the double-sided tape 141B being interposed between the first sheet 140A and the protrusion-equipped second sheet 142. In such a state, the protrusion-equipped second sheet 142 covers the first sheet 140A and the flange 130F, and the protrusion 142a at the peripheral edge part of the protrusion-equipped second sheet 142 is positioned so as to outwardly protrude beyond the outer surface 130S of the housing 130.

Note that the preparation step and the first step may be performed in reverse order. For example, the following process may be employed. After polarizing plates 114A, 114B are bonded respectively to surfaces of substrates 111A, 111B forming the display panel 110, and the first sheet 140A is further bonded to a surface of the polarizing plate 114B, a high-density multichip system-on-film (SOF) and a printed wiring board (hereinafter referred to as a “PWB”) may be mounted on the display panel 110, and assembling may be performed such that the display panel 110 and the backlight unit 120 are accommodated in the housing 130. Alternatively, after the high-density multichip SOF and the PWB are mounted, the first sheet 140A and the second sheet 140B may be bonded, and assembling may be performed such that the display panel 110 and the backlight unit 120 are accommodated in the housing 130. As still another alternative, after the first sheet 140A is bonded to the surface of the polarizing plate 114B of the display panel 110 to which the double-sided tape 141A is bonded, and the double-sided tape 141B is bonded to the surface of the first sheet 140A, assembling may be performed such that the display panel 110 and the backlight unit 120 are accommodated in the housing 130.

Second Step

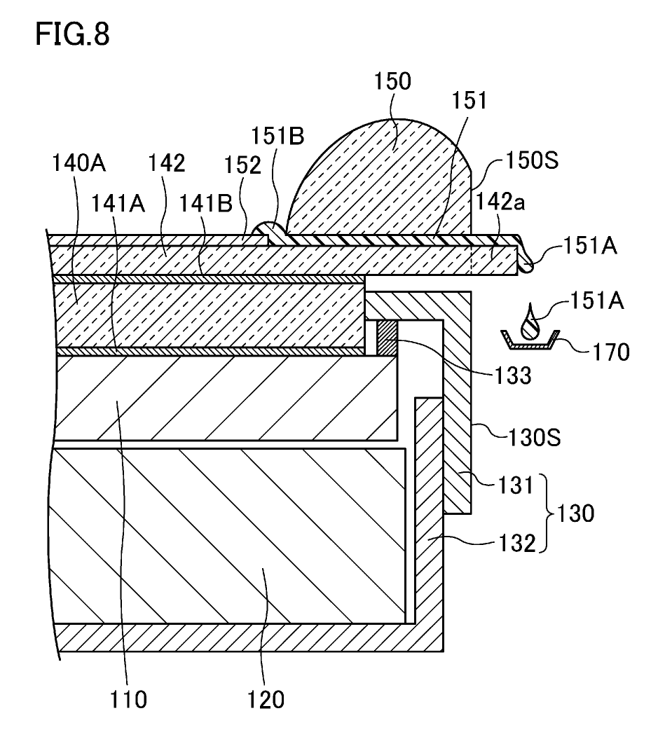

Next, a gutter-shaped adhesive receiver 170 is, referring to FIG. 8, placed at a position right below a peripheral end of the protrusion 142a so as to surround an outer periphery of the protrusion-equipped second sheet 142. The adhesive receiver 170 is formed in such a manner that, e.g., a stainless material is processed.

Subsequently, an adhesive 151 is, at step S121, applied to a surface of the light guide member 150 to which the protrusion-equipped second sheet 142 is bonded. Then, at step S122, the light guide member 150 to which the adhesive 151 is applied is arranged at a peripheral edge part in a region of the protrusion-equipped second sheet 142 to be the second sheet 140B. In such a state, the light guide member 150 is arranged such that an outer peripheral end surface 150S of the light guide member 150 and the outer surface 130S of the front housing part 131 are flush with each other. Moreover, the position where the light guide member 150 is arranged does not overlap with the cover film 152.

Since the light guide member 150 is arranged on the protrusion-equipped second sheet 142, the adhesive 151 spreads, by pressing, and flows beyond the region where the light guide member 150 is bonded. An adhesive 151A flowing toward the protrusion 142a spreads along the protrusion 142a, and part of the adhesive 151A drops down from the peripheral end of the protrusion 142a. The adhesive 151A dropping down from the peripheral end of the protrusion 142a is received by the adhesive receiver 170 placed right below the peripheral end of the protrusion 142a. Of the adhesive 151, an adhesive 151B spreading toward the display region is, by the cover film 152, prevented from spreading on the protrusion-equipped second sheet 142, and part of the adhesive 151B flows over the cover film 152. If it is difficult to remove the cured adhesive 151B, the adhesive 151B flowing over the cover film 152 is wiped off.

Note that, after the adhesive 151 is applied to the peripheral edge part of the protrusion-equipped second sheet 142, the light guide member 150 may be arranged thereon.

Third Step

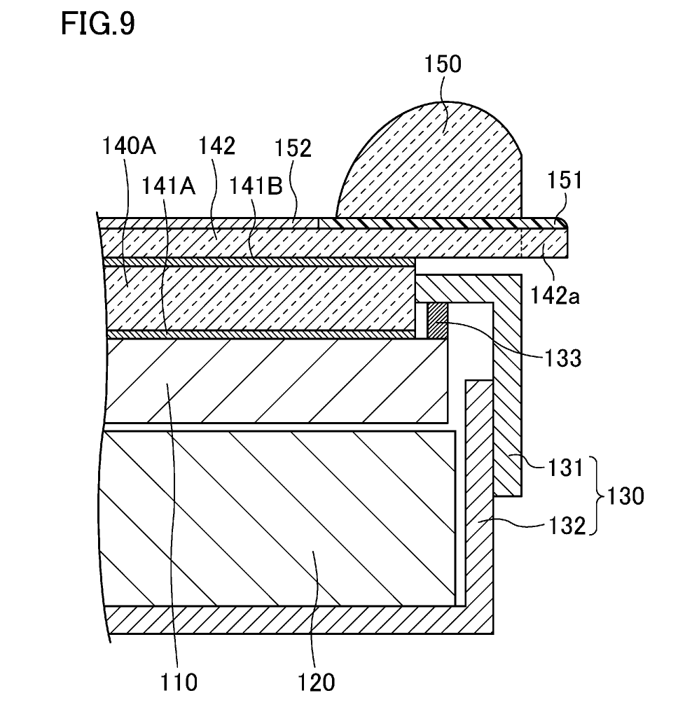

Next, at step S131, the adhesive 151 interposed between the light guide member 150 and the protrusion-equipped second sheet 142 is, referring to FIG. 9, cured by ultraviolet irradiation and/or heating. If the adhesive 151 is cured by ultraviolet irradiation, the adhesive 151 may be irradiated with ultraviolet light in the state in which a region other than the light guide member 150 is masked. The light guide member 150 is bonded to the protrusion-equipped second sheet 142 in the foregoing manner.

Fourth Step

Subsequently, at step S141, the protrusion 142a is, referring to FIG. 10, cut off from the protrusion-equipped second sheet 142 by, e.g., an acrylic cutter. In such a state, the protrusion 142a is cut off from the protrusion-equipped second sheet 142 such that the outer surface 130S of the front housing part 131 and the outer peripheral end surface 150S of the light guide member 150 are flush with each other. As a result of cutting off the protrusion 142a from the protrusion-equipped second sheet 142, only part of the protrusion-equipped second sheet 142 to be the second sheet 140B remains.

Next, a clearance between the flange 130F and the first sheet 140A is adjusted by screw tightening (not shown in the figure) from the side of the front housing part 131 such that a surface 131A forming the window 131W is fixed to the first sheet 140A in contact with a side surface thereof.

Finally, the cover film 152 is detached from the surface of the second sheet 140B. As a result, a display apparatus 100 is formed.

It has been described that the cover film 152 is pre-bonded to the protrusion-equipped second sheet 142 at the step at which the protrusion-equipped second sheet 142 is prepared. However, the present disclosure is not limited to such a process. For example, after the protrusion-equipped second sheet 142 is bonded onto the first sheet 140A at step S114, the cover film 152 may be bonded onto the protrusion-equipped second sheet 142.

Moreover, it has been described that the cover film 152 is bonded to the surface of the protrusion-equipped second sheet 142 opposite to the first sheet 140A and then the light guide member 150 is arranged with the adhesive 151 being interposed between the protrusion-equipped second sheet 142 and the light guide member 150. However, the step of bonding the cover film 152 is not necessarily performed. If the cover film 152 is not bonded, the adhesive 151 spreads by pressing when the light guide member 150 is pressed against the adhesive 151, and the surface of the protrusion-equipped second sheet 142 is fouled with the adhesive 151. Thus, a solvent of, e.g., acetone is used to wipe off the adhesive 151 spreading on the surface of the protrusion-equipped second sheet 142.

### Advantages of First Embodiment

According to the first embodiment, since the protrusion-equipped second sheet 142 is arranged so as to cover the outer surface of the flange 130F of the housing 130 at the first step, the adhesive 151 does not drop into the housing 130 even if the adhesive 151 spreads due to the light guide member 150 arranged on a predetermined part of the protrusion-equipped second sheet 142 at the second step.

Moreover, according to the first embodiment, the protrusion-equipped second sheet 142 including the protrusion 142a protruding outward is stacked on the surface of the display panel 110 at the first step. Thus, even if the adhesive 151 spreads due to the light guide member 150 arranged on the predetermined part of the protrusion-equipped second sheet 142 at the second step, fouling of an outer part of the housing 130 or the periphery thereof with the adhesive 151A splattered upon dropping from the protrusion 142a to the outside of the housing 130 is reduced. Further, since the adhesive receiver 170 is placed right below the peripheral end of the protrusion 142a in the first embodiment, the adhesive 151A dropping down from the protrusion 142a is received by the adhesive receiver 170 placed right below the peripheral end of the protrusion 142a. Thus, fouling of the outer part of the housing 130 or the periphery thereof with the adhesive 151A splattered upon dropping is more efficiently reduced. The adhesive 151A accumulated in the adhesive receiver 170 can be recovered and reused, and therefore the adhesive 151 can be efficiently used.

### Variations of First Embodiment

Next, variations of the first embodiment will be described.

(First and Second Variations)

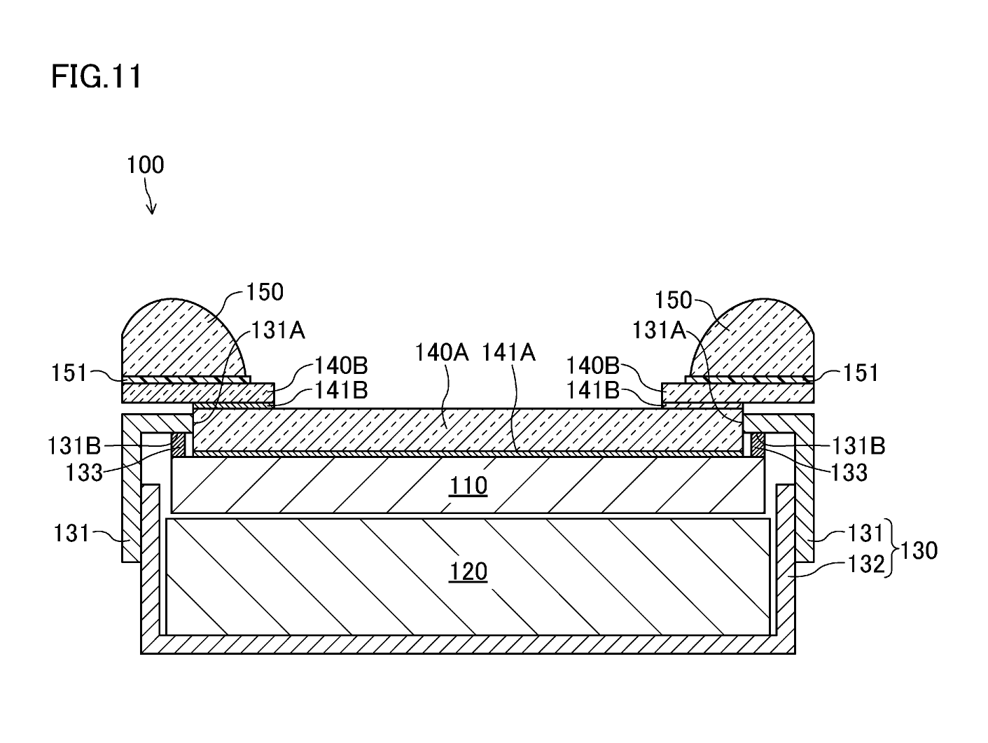

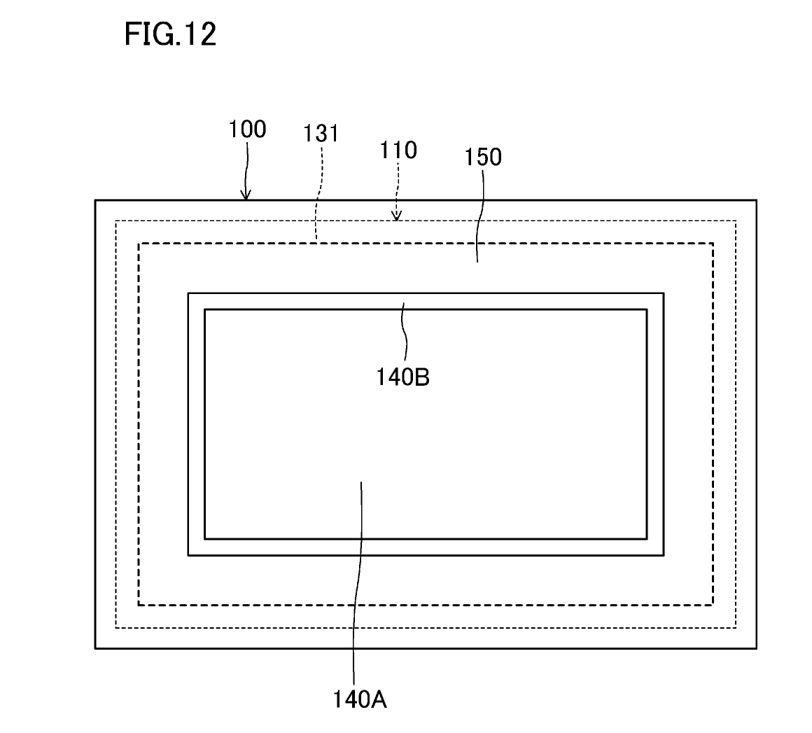

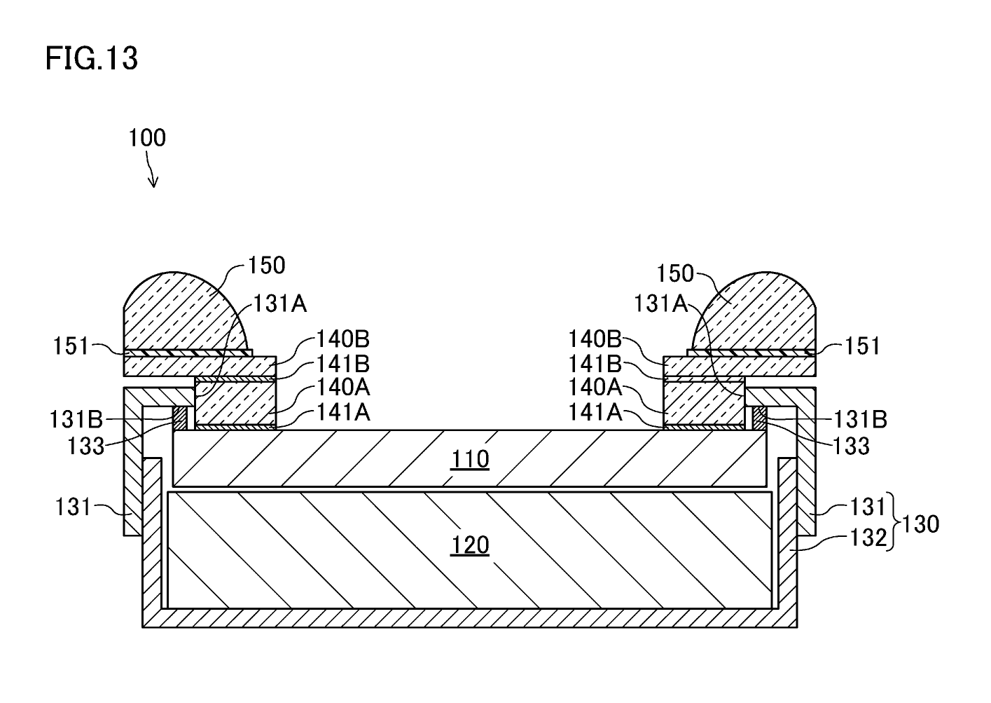

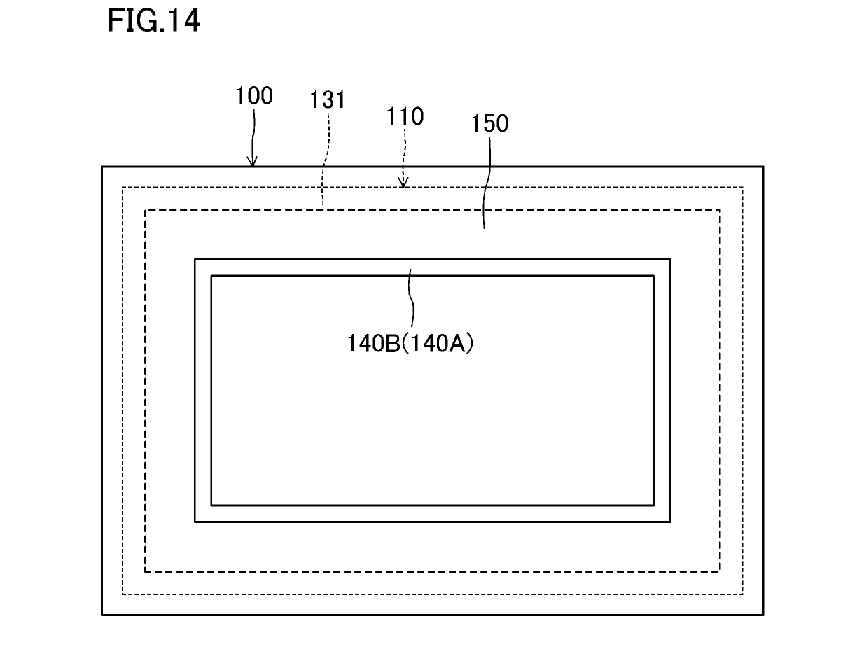

In the first embodiment, it has been described that the first sheet 140A is provided so as to cover at least the entirety of the display region of the display panel 110 and the second sheet 140B is provided so as to cover the entirety of the surface of the first sheet 140A opposite to the display panel 110. However, the present disclosure is not limited to such a configuration. For example, as in a first variation illustrated in FIGS. 11 and 12, the second sheet 140B having a frame shape may be bonded so as to cover a peripheral edge part of the first sheet 140A. Moreover, as in a second variation illustrated in FIGS. 13 and 14, the first sheet 140A having a frame shape may be provided so as not to cover a center part of the display region of the display panel 110, and the frame-shaped second sheet 140B may be provided so as to cover the peripheral edge part of the first sheet 140A.

In the first and second variations, the adhesive 151 bonding the light guide member 150 is, as in the first embodiment, prevented from dropping into the housing 130, and fouling of the outer part of the housing 130 or the periphery thereof with the adhesive 151A splattered upon dropping to the outside of the housing 130 is reduced.

(Third Variation)

In the first embodiment, it has been described that the acrylic sheet made of acrylic resin is used as the first sheet 140A. However, a touch panel sheet 160 may be bonded instead of the first sheet 140A.

The touch panel sheet 160 may be a resistive touch panel sheet, an electrostatic capacitive touch panel sheet (analog capacitive coupling touch panel sheet), an ultrasonic touch panel sheet, or any other types of touch panel sheets.

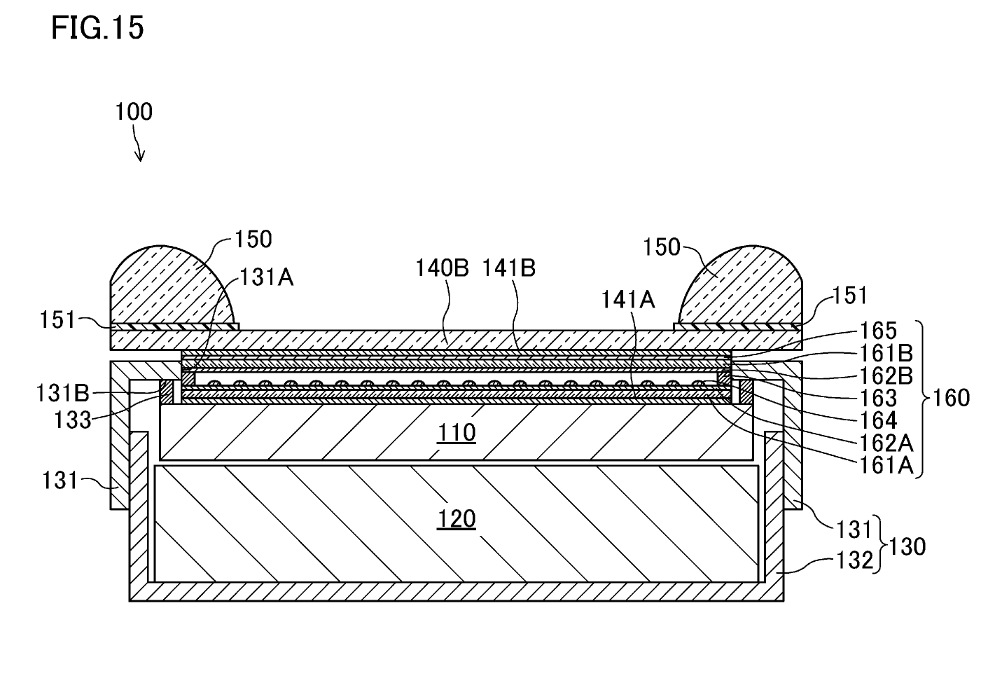

The display apparatus 100 in the case where the resistive touch panel sheet is employed as the touch panel sheet 160 will be described below as a third variation with reference to FIG. 15. In the touch panel sheet 160, a first base in which a transparent conductive film 162A such as an ITO film is provided on a surface of a transparent film 161A and a second base in which a transparent conductive film 162B such as an ITO film is provided on a surface of a transparent film 161B are arranged such that the transparent conductive films 162A, 162B face each other. The first and second bases are bonded together with a double-sided tape 163 provided at peripheral edge parts of the first and second bases. Dot spacers 164 made of, e.g., epoxy resin are provided with predetermined pitches on a surface of the transparent conductive film 162A of the first base. Moreover, a hard coat film 165 formed in such a manner that, e.g., hard resin such as acrylic urethane-based resin or siloxane-based resin is applied and cured is provided on a surface of the transparent film 161B of the second base.

A material having a refractive index of 1.3-1.7 is suitable for the transparent films 161A, 161B which are the bases of the touch panel sheet 160. Thus, light refraction at, e.g., an interface between the display panel 110 and the transparent film 161A of the touch panel sheet 160 can be reduced. For example, a polyethylene terephthalate (PET) film (having a refractive index of 1.58), a polyethylene naphthalate (PEN) film (having a refractive index of 1.64), a polycarbonate (PC) film (having a refractive index of 1.58), or a glass film (having a refractive index of 1.5) can be used as the material of the transparent films 161A, 161B.

The third variation is similar to the first embodiment in configuration, except that the touch panel sheet 160 is used instead of the first sheet 140A.

In the third variation, the adhesive 151 bonding the light guide member 150 is, as in the first embodiment, prevented from dropping into the housing 130, and fouling of the outer part of the housing 130 or the periphery thereof with the adhesive 151A splattered upon dropping to the outside of the housing 130 is reduced.

(Other Variations)

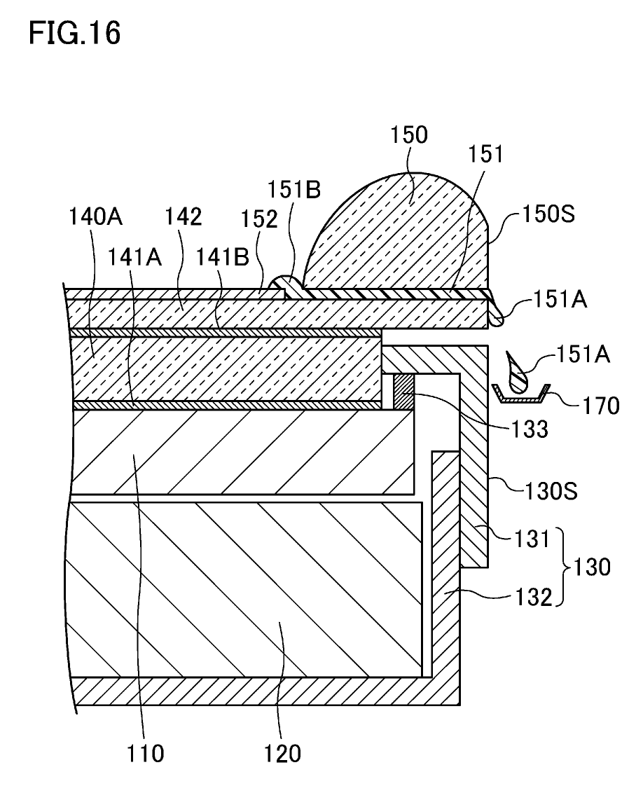

In the first embodiment, it has been described that the protrusion-equipped second sheet 142 is stacked at the first step. However, a second sheet 142 may include no protrusion as in, e.g., a fourth variation illustrated in FIG. 16. In such a case, since the second sheet 142 is also arranged so as to cover the flange 130F of the housing 130, the adhesive 151 does not drop into the housing 130. Note that the fourth step is, in this case, not necessary in the manufacturing method.

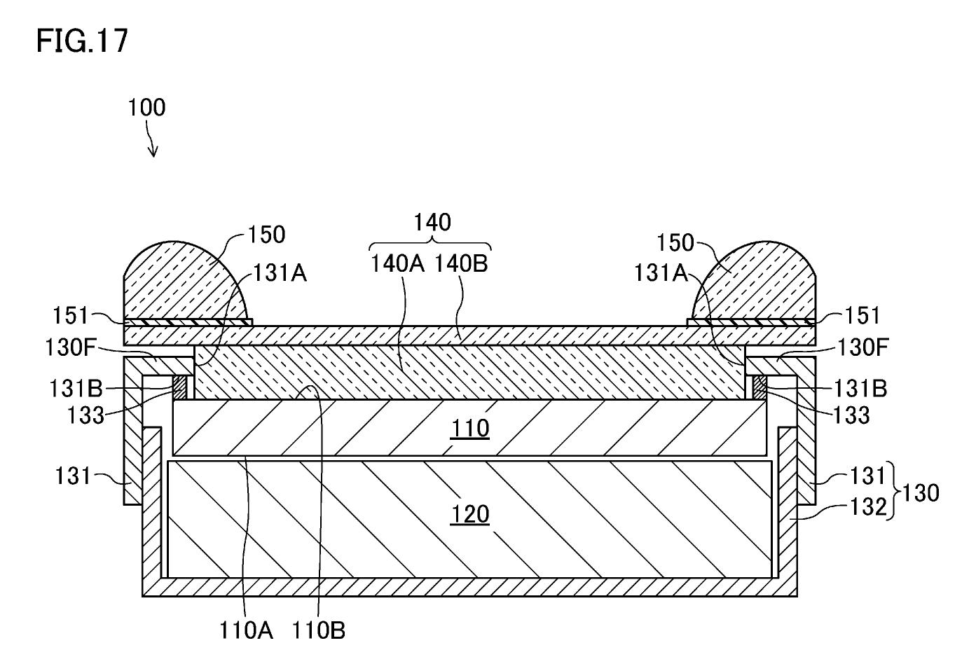

In the first embodiment, it has been described that the first sheet 140A is made of acrylic resin. However, the first sheet 140A may be made of a transparent elastic material such as an acrylic gel sheet or a silicone rubber sheet. For example, if the first sheet is the acrylic gel sheet, the acrylic gel sheet itself has viscosity, and therefore the double-sided tape 141A configured to bond the display panel 110 and the first sheet 140A together and the double-sided tape 141B configured to bond the first sheet 140A and the second sheet 140B together can be omitted as necessary as in a fifth variation illustrated in FIG. 17.

In the first embodiment, it has been described that the second sheet 140B is made of acrylic resin. However, the second sheet 140B may be, e.g., an acrylic gel sheet, a PET film, or a TAC film. If the second sheet 140B is the acrylic gel sheet, the protrusion 142a is also formed of the acrylic gel sheet. Thus, the adhesive is, due to viscosity of the acrylic gel sheet, less likely to flow down, and the protrusion 142a can be easily cut off. If the second sheet 140B is the PET film or the TAC film, the protrusion 142a is also formed of the PET film or the TAC film. Thus, excellent chemical resistance can be realized, and the protrusion 142a can be easily cut off.

In the first embodiment, it has been described that the surface 131A forming the window 131W contacts the side surface of the first sheet 140A. However, the surface 131A forming the window 131W and the side surface of the first sheet 140A may be apart from each other.

In the first embodiment, it has been described that the frame-shaped light guide member 150 is provided so as to cover the outer peripheral edge part of the display panel. However, the light guide member 150 may be provided in a region of the outer peripheral edge part of the display panel 110 of one of the display apparatuses 100 which is adjacent to another one of the display apparatuses 100 when the display apparatuses 100 are combined together to form the large-screen display 300.

### Second Embodiment

### Display Apparatus

Subsequently, a display apparatus 100 of a second embodiment of the present disclosure will be described. As in the first embodiment, a plurality of display apparatuses 100 are combined together to form a multi-display system 10.

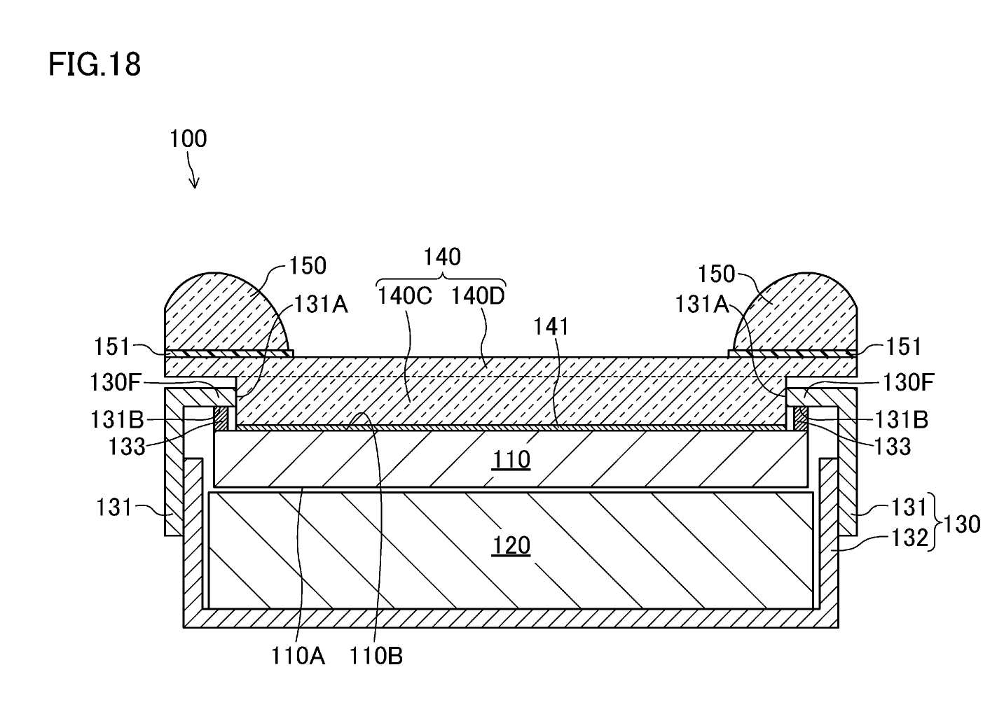

FIG. 18 is a cross-sectional view of the display apparatus 100 of the second embodiment. The display apparatus 100 includes a display panel 110 configured to display an image, a backlight unit 120 configured to output light to the display panel 110, a housing 130 containing the display panel 110 and the backlight unit 120, a cover member 140 configured to cover and protect a surface of the display panel 110 on an image display side 110B, and a light guide member 150 provided corresponding to a peripheral edge part of the display panel 110.

The cover member 140 is bonded to the surface of the display panel 110 on the image display side 110B with a double-sided tape 141 so as to cover the entirety of a display region of the display panel 110. The cover member 140 includes a first cover part 140C forming part of the cover member 140 close to the display panel 110 in a thickness direction thereof, and a second cover part 140D forming the remaining part of the cover member 140 in the thickness direction thereof. The first cover part 140C is formed in size corresponding to a window 131W of a front housing part 131, and is fitted into the window 131W. The second cover part 140D has an outer peripheral edge part outwardly protruding beyond the first cover part 140C, and is formed so as to be slightly larger than the first cover part 140C. Moreover, the outer peripheral edge part of the second cover part 140D covers an outer surface of a flange 130F. The first cover part 140C has a thickness of, e.g., 0.1-1 mm. The second cover part 140D has a thickness of, e.g., 0.01-0.5 mm.

The cover member 140 and the double-sided tape 141 preferably have a refractive index of 1.3-1.7, and more preferably a refractive index of close to 1.5. The refractive index of glass forming the display panel 110 and the refractive index of a polarizing plate 114B are about 1.5. The cover member 140 and the double-sided tape 141 are made of a material having a refractive index close to such a value to suppress light refraction at, e.g., an interface between the display panel 110 and the double-sided tape 141 and an interface between the double-sided tape 141 and the cover member 140. Examples of the material of the cover member 140 include acrylic resin (having a refractive index of 1.49). In terms of chemical resistance and abrasion resistance, acrylic resin is also suitable as the material of the cover member 140. Moreover, examples of the material of the double-sided tape 141 include a tape (having a refractive index of about 1.5) made of an acrylic-based resin material. Specifically, e.g., an optical clear adhesive (OCA) tape and an acrylic gel sheet can be used as the double-sided tape 141. For example, commercialized products such as high-transparency adhesive transfer tapes manufactured by Sumitomo 3M Ltd. can be used as the OCA tape. Moreover, e.g., bunshikoubaimaku super adhesive force double coated tapes (trademark registered by Kyodo Giken Chemical Co., Ltd.) can be used as the acrylic gel sheet. For example, commercialized products such as “300Z series” manufactured by Kyodo Giken Chemical Co., Ltd. can be used.

The second embodiment is similar to the first embodiment in configuration, except for the cover member 140.

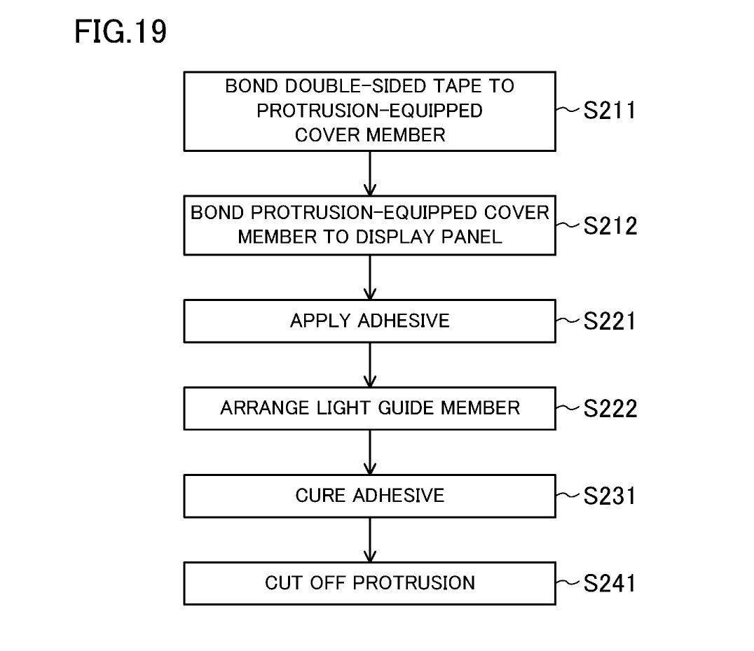

(Method for Manufacturing Display Apparatus) Next, a method for manufacturing the display apparatus 100 having the foregoing configuration will be described. Each of a preparation step, a first step, a second step, a third step, and a fourth step will be described herein with reference to a flowchart illustrated in FIG. 19.

Preparation Step

First, a display panel 110, a backlight unit 120, a front housing part 131, a back housing part 132, a protrusion-equipped cover member 143, and a light guide member 150 are prepared. Note that the display panel 110 is formed in a conventionally-known method.

The protrusion-equipped cover member 143 is integrally formed of the followings: a first cover part 140C which is part of the protrusion-equipped cover member 143 in a thickness direction thereof and which can be fitted into a window 131W of the front housing part 131; a second cover part 140D which continues from the first cover part 140C in the thickness direction of the protrusion-equipped cover member 143 and which has an area slightly larger than that of the first cover part 140C; and a protrusion 143a which further protrudes to the outside of a housing 130 beyond the second cover part 140D. The first cover part 140C and the second cover part 140D correspond to part of the protrusion-equipped cover member 143 which is to be a cover member 140. The protrusion-equipped cover member 143 is formed such that the length of the protrusion from the second cover part 140D is, e.g., 100 μm to 1 mm.

A cover film 152 is pre-bonded to a surface of the protrusion-equipped cover member 143 opposite to the display panel 110. The cover film 152 is positioned in a region surrounded by a region where the light guide member 150 is arranged. For example, a film made of polyethylene terephthalate (PET) or triacetylcellulose (TAC) may be used as the cover film 152.

First Step

First, the display panel 110, the backlight unit 120, the front housing part 131, and the back housing part 132 are, as in the first embodiment, assembled together such that the display panel 110 and the backlight unit 120 are accommodated in the housing 130.

Next, at step S211, a double-sided tape 141 is bonded to a surface of the protrusion-equipped cover member 143 close to the display panel 110. Then, at step S212, the protrusion-equipped cover member 143 is bonded so as to cover a surface of a display region of the display panel 110 on an image display side 110B with the double-sided tape 141 being interposed between the protrusion-equipped cover member 143 and the display panel 110. In such a state, the first cover part 140C of the protrusion-equipped cover member 143 is fitted into the window 131W of the front housing part 131, and an outer peripheral edge part of the second cover part 140D covers an outer surface of a flange 130F. Moreover, the protrusion 143a is positioned so as to outwardly protrude beyond an outer surface 130S of the housing 130.

Second Step

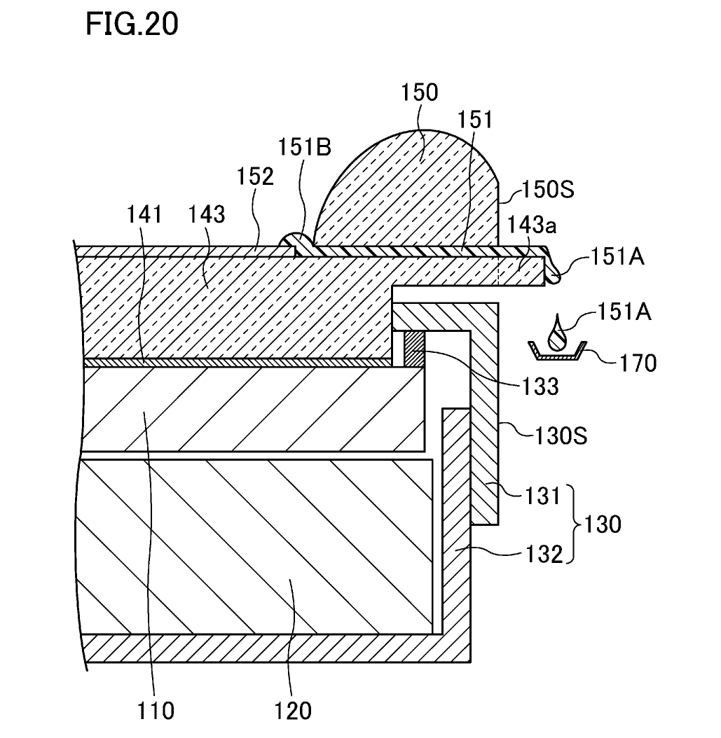

Next, a gutter-shaped adhesive receiver 170 is, referring to FIG. 20, placed at a position right below a peripheral end of the protrusion 143a so as to surround an outer periphery of the protrusion-equipped sheet.

Subsequently, an adhesive 151 is, at step S221, applied to a surface of the light guide member 150 to which the protrusion-equipped cover member 143 is bonded. Then, at step S222, the light guide member 150 to which the adhesive 151 is applied is arranged at the peripheral edge part of the second cover part 140D of the protrusion-equipped cover member 143. In such a state, the light guide member 150 is arranged such that an outer peripheral end surface 150S of the light guide member 150 and the outer surface 130S of the front housing part 131 are flush with each other. Moreover, the position where the light guide member 150 is arranged does not overlap with the cover film 152.

Since the light guide member 150 is arranged on the protrusion-equipped cover member 143, the adhesive 151 spreads, by pressing, and flows beyond the region where the light guide member 150 is bonded. An adhesive 151A flowing out toward the protrusion 143a spreads along the protrusion 143a, and part of the adhesive 151A drops down from the peripheral end of the protrusion 143a. The adhesive 151A dropping down from the peripheral end of the protrusion 143a is received by the adhesive receiver 170 placed right below the peripheral end of the protrusion 143a. Of the adhesive 151, an adhesive 151B spreading toward the display region is, by the cover film 152, prevented from spreading on the protrusion-equipped cover member 143, and part of the adhesive 151B flows over the cover film 152. Note that the adhesive 151B flowing over the cover film 152 is wiped off.

Note that, after the adhesive 151 is applied to the surface of the protrusion-equipped cover member 143, the light guide member 150 may be arranged thereon.

Third Step

Next, at step S231, the adhesive 151 interposed between the light guide member 150 and the protrusion-equipped cover member 143 is, as in the first embodiment, cured by ultraviolet irradiation and/or heating.

Fourth Step

Subsequently, at step S241, the protrusion 143a is, as in the first embodiment, cut off from the protrusion-equipped cover member 143. In such a state, the protrusion 143a is cut off from the protrusion-equipped cover member 143 such that the outer surface 130S of the front housing part 131 and the outer peripheral end surface 150S of the light guide member 150 are flush with each other. As a result of cutting off the protrusion 143a from the protrusion-equipped cover member 143, only part of the protrusion-equipped cover member 143 which is to be the cover member 140 remains.

Next, a clearance between the flange 130F and the first cover part 140C is adjusted by screw tightening (not shown in the figure) from the side of the front housing part 131 such that a surface 131A forming the window 131W is fixed to the cover member 140 in contact with a side surface thereof.

Finally, the cover film 152 is detached from the surface of the cover member 140. As a result, a display apparatus 100 is formed.

### Advantages of Second Embodiment

According to the second embodiment, since the protrusion-equipped sheet is, at the first step, arranged such that the peripheral edge part of the second cover part 140D of the protrusion-equipped cover member 143 covers the outer surface of the flange 130F of the housing 130, the adhesive 151 does not drop into the housing 130 even if the adhesive 151 spreads due to the light guide member 150 arranged on a predetermined part of the protrusion-equipped cover member 143 at the second step.

Moreover, according to the second embodiment, the protrusion-equipped cover member 143 including the protrusion 143a outwardly protruding beyond the second cover part 140D is stacked on the surface of the display panel 110 at the first step. Thus, even if the adhesive 151 spreads due to the light guide member 150 arranged on the predetermined part of the protrusion-equipped cover member 143 at the second step, fouling of an outer part of the housing 130 or the periphery thereof with the adhesive 151A splattered upon dropping from the end part of the protrusion-equipped sheet to the outside of the housing 130 is reduced. Further, since the adhesive receiver 170 is placed right below the peripheral end of the protrusion 143a in the second embodiment, the adhesive 151A dropping down from the peripheral end of the protrusion 143a is received by the adhesive receiver 170 placed right below the peripheral end of the protrusion 143a. Thus, fouling of the outer part of the housing 130 or the periphery thereof with the adhesive 151A splattered upon dropping is more efficiently reduced.

### Third Embodiment

### Display Apparatus

Next, a display apparatus 100 of a third embodiment of the present disclosure will be described. As in the first embodiment, a plurality of display apparatuses 100 are combined together to form a multi-display system 10.

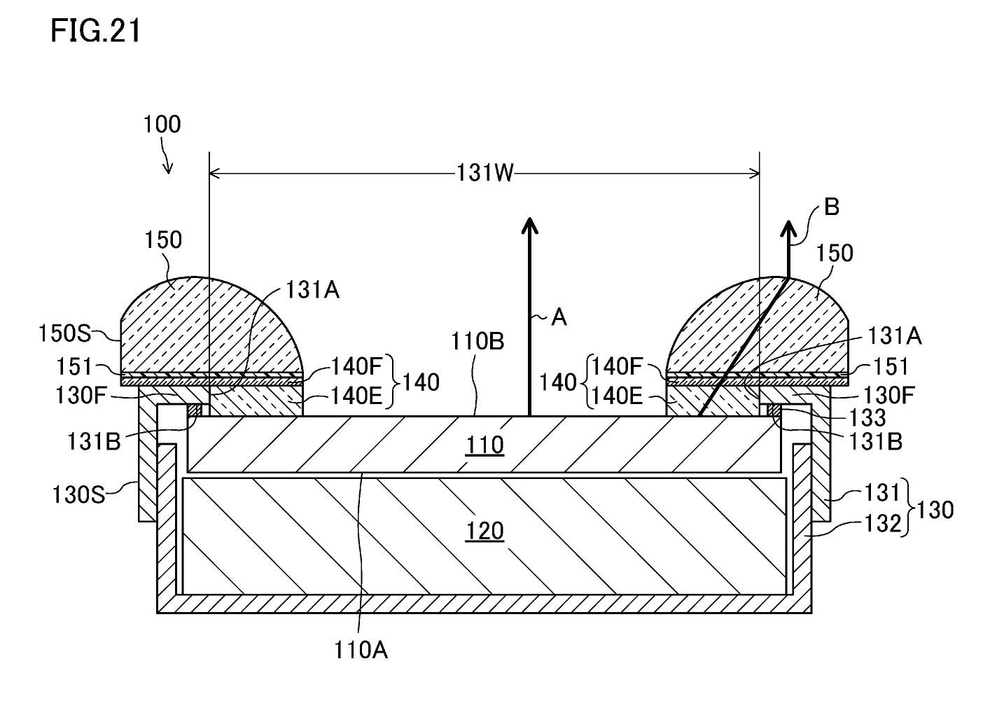

FIG. 21 is a cross-sectional view of the display apparatus 100 of the third embodiment. The display apparatus 100 includes a display panel 110 configured to display an image, a backlight unit 120 configured to output light to the display panel 110, a housing 130 containing the display panel 110 and the backlight unit 120, a cover member 140 configured to cover and protect a surface of the display panel 110 on an image display side 110B, and a light guide member 150 provided corresponding to a peripheral edge part of the display panel 110.

The display panel 110 includes two substrates 111A, 111B arranged so as to face each other, a sealing material 112 provided in a frame shape between the substrates 111A, 111B at the peripheral edge part of the display panel 110 and configured to bond the substrates 111A, 111B together, a liquid crystal layer 113 provided in a region surrounded by the sealing material 112, and polarizing plates 114A, 114B provided respectively on surfaces of the substrates 111A, 111B opposite to the liquid crystal layer 113 (see FIG. 5). Note that the substrate 111A and the polarizing plate 114A are arranged on a backlight unit side 110A of the display panel 110, and the substrate 111B and the polarizing plate 114B are arranged on the image display side 110B of the display panel 110. The display panel 110 preferably has a diagonal line length of equal to or greater than 812 mm (32-inch size), and more preferably about 60-inch size, i.e., a vertical length of 747 mm and a horizontal length of 1328 mm.

The backlight unit 120 is arranged so as to face a surface of the display panel 110 on a side close to the polarizing plate 114A. Although not shown in the figure, the backlight unit 120 includes, e.g., a light source such as a cold cathode fluorescent tube or a light emitting diode (LED), a light guide plate configured to guide light from the light source to the display panel 110, and a diffuser plate. When passing through the liquid crystal layer 113 via the substrate 111A, the transmittance of light guided by the light guide plate and entering the display panel 110 is adjusted according to an alignment direction of liquid crystal molecules. Then, the light is output from the substrate 111B on the image display side, thereby displaying an image.

The housing 130 includes, e.g., a front housing part 131 containing the display panel 110, and a back housing part 132 supporting the backlight unit 120.

A window 131W is formed at a bottom part of the front housing part 131, and a flange 130F forming a window frame of the window 131W is provided so as to extend inward. The display panel 110 and part of a cover member 140E in a thickness direction thereof are arranged inside the front housing part 131. The display panel 110 is positioned inside the front housing part 131 such that a displayed image can be viewed from the outside through the window 131W. A frame-shaped spacer 133 is formed along the peripheral edge part of the display panel 110 on the surface of the display panel 110 on the image display side 110B. The front housing part 131 is fixed to the cover member 140E in the state in which a surface 131A forming the window 131W contacts a side surface of the cover member 140E. Moreover, an inner surface 131B of the flange 130F contacts a tip end of the spacer 133, and therefore the display panel 110 and the front housing part 131 are fixed together.

The back housing part 132 is in a rectangular box shape with a closed bottom, and the backlight unit 120 is arranged inside the back housing part 132. A bottom surface of the backlight unit 120 is fixed to a bottom surface of the back housing part 132, and therefore the backlight unit 120 is supported by the back housing part 132. Moreover, an inner side wall surface of the front housing part 131 contacts an outer side wall surface of the back housing part 132, and therefore the front housing part 131 and the back housing part 132 are supported against each other.

The frame-shaped spacer 133 is interposed between the inner surface 131B of the flange 130F and a surface of the peripheral edge part of the display panel 110 on the image display side 110B so that the flange 130F and the display panel 110 are fixed together. The spacer 133 is made of, e.g., silicone rubber (commercialized products such as a silicone rubber adhesive tape manufactured by Teraoka Seisakusho Co., Ltd.). The spacer 133 has a height of, e.g., 0.1-0.2 mm.

The cover member 140 includes the first cover member 140E and a second cover member 140F. The first cover member 140E and the second cover member 140F both having a frame shape are provided so as to cover the surface of the peripheral edge part of the display panel 110 on the image display side 110B.

The frame-shaped first cover member 140E is bonded to the surface of the display panel 110 on the image display side 110B so as to cover the peripheral edge part of the display panel 110. The first cover member 140E is formed in size corresponding to the window 131W of the front housing part 131, and is fitted into the window 131W. The first cover member 140E has a thickness larger than that of the flange 130F of the front housing part 131, and the thickness of the first cover member 140E is, e.g., 0.1-1 mm.

The first cover member 140E is made of a transparent elastic material. Examples of the transparent elastic material include an acrylic gel sheet, a silicone rubber sheet, and a polyurethane gel sheet. Since the first cover member 140E is made of the transparent elastic material, the first cover member 140E itself has properties such as viscosity, flexibility, and elasticity. Due to the viscosity of the first cover member 140E, the first cover member 140E can be stacked on the surface of the display panel 110 without using an adhesive such as a double-sided tape, and the second cover member 140F can be stacked on the first cover member 140E without using an adhesive. Moreover, due to the viscosity of the first cover member 140E, the first cover member 140E bonded onto the display panel 110 can be easily removed. Further, due to the flexibility of the first cover member 140E, the first cover member 140E can be bonded with reduction in air bubbles etc. entering between the display panel 110 and the first cover member 140E. Still further, due to the elasticity of the first cover member 140E, stress applied between the display panel 110 and the light guide member 150 is absorbed, and therefore panel strength can be enhanced.

The frame-shaped second cover member 140F is provided so as to cover a surface of the first cover member 140E opposite to the display panel 110 and a surface of the flange 130F. The second cover member 140F has a thickness of, e.g., 0.01-0.5 mm.

The second cover member 140F is formed of a polyethylene terephthalate (PET) resin sheet. Since the second cover member 140F is formed of the PET resin sheet, the second cover member 140F has flexibility. Thus, the second cover member 140F can be easily bonded onto the first cover member 140E with reduction in air bubbles etc. entering between the first cover member 140E and the second cover member 140F. Moreover, the second cover member 140F made of PET resin has advantages such as high chemical resistance and a low material cost.

The light guide member 150 having a frame shape is provided at a peripheral edge part of the second cover member 140F on a surface thereof opposite to the first cover member 140E. As viewed in the cross section illustrated in FIG. 21, the light guide member 150 is in, e.g., a shape formed of a straight line contained in a plane facing the second cover member 140F, a straight line defining a peripheral end surface 150S of the light guide member 150, and a curved line defining a curved surface which connects the foregoing two straight lines and which protrudes toward the image display side. The light guide member 150 is made of, e.g., a transparent insulating material such as acrylic resin. The light guide member 150 has a width of, e.g., 10-100 mm and a thickness of, e.g., 10-30 mm.

In a region of the display panel 110 where no light guide member 150 is provided, light output from the display panel 110 configured to display an image is, on average, output perpendicular to the display panel 110 as indicated by an arrow A illustrated in FIG. 21. On the other hand, since the light guide member 150 is provided at the peripheral edge part of the display panel 110 on the image display side, light is, as indicated by an arrow B illustrated in FIG. 21, refracted at the curved surface of the light guide member 150 in the peripheral edge part of the display panel 110 when passing through the light guide member 150, and then the light travels toward the outside of the display panel 110. Thus, in the case where the plurality of display apparatuses 100 are used to form the multi-display system 10 including a large-screen display 300, and each enlarged portion of an image is displayed on a corresponding one of the display apparatuses 100, light output from the display panel 110 through the peripheral edge part thereof is guided to the outside of the display panel 110. Thus, images can be easily viewed at a seam between adjacent ones of the display apparatuses 100, and therefore the seam becomes less noticeable.

The light guide member 150 is bonded to a surface of the second cover member 140F with an adhesive 151. Examples of the adhesive 151 include ultraviolet curable resin and thermoset resin.

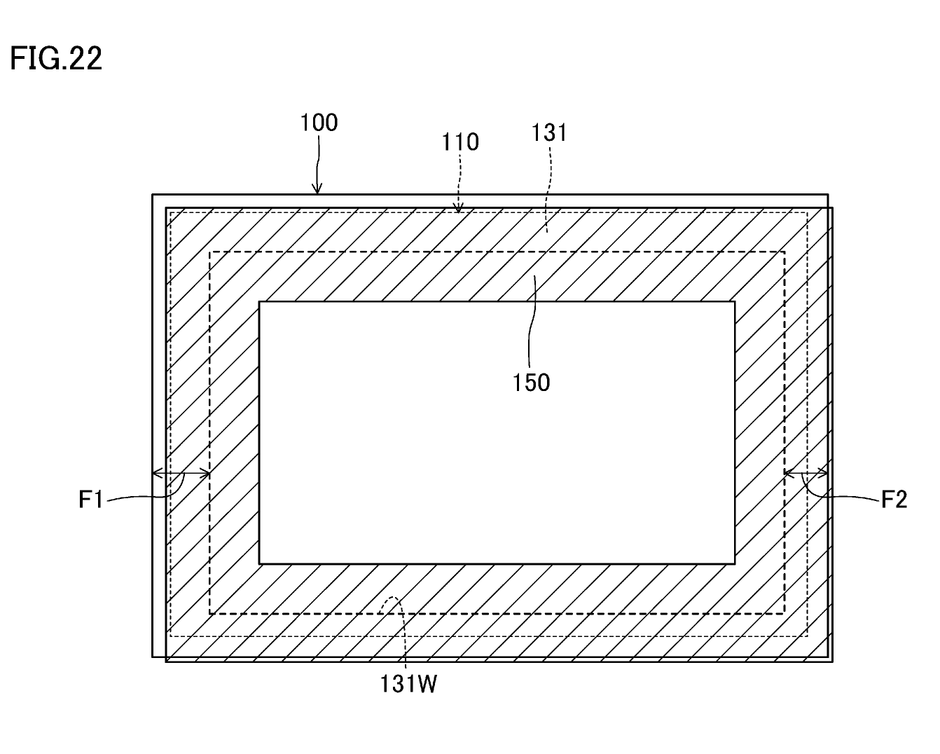

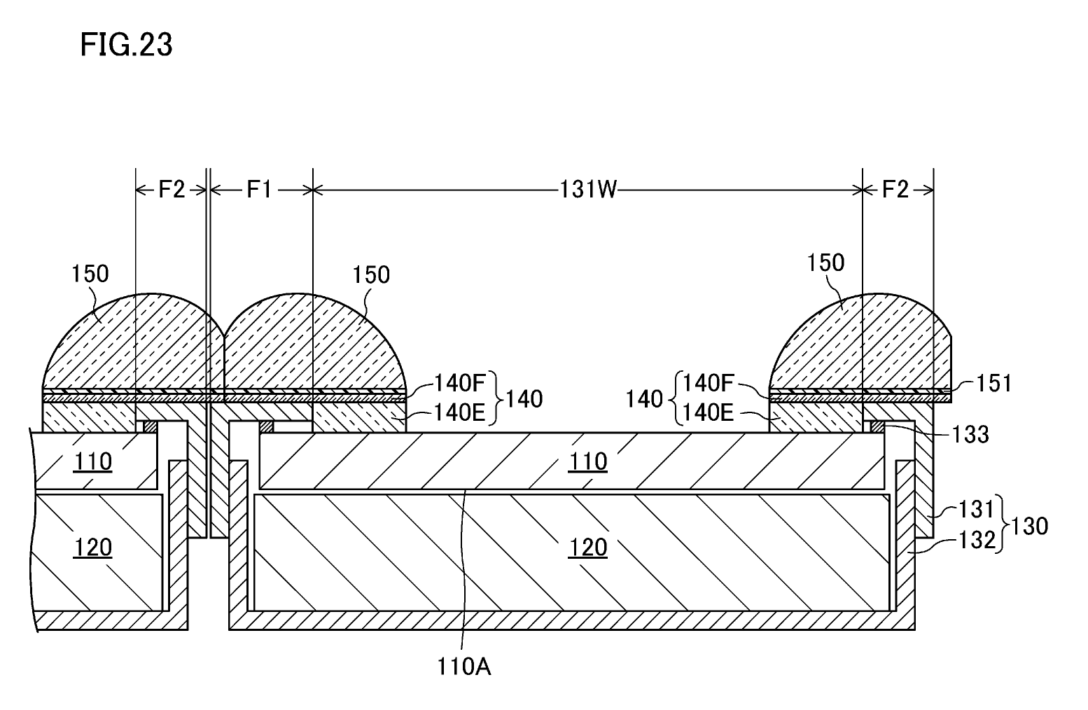

Although an outer peripheral end surface of the light guide member 150 is positioned on the outer side relative to an outer surface of the housing 130 in FIG. 21, the present disclosure is not limited to such a configuration. For example, in the case where the width of a frame region is different among sides of the display panel as in a sixth variation illustrated in FIGS. 22 and 23, the outer peripheral end surface of the light guide member 150 may be positioned on the inner side relative to the outer surface of the housing 130 in a wide part (“F1” on the left side as viewed in FIG. 22) of the frame region of the display apparatus, whereas the outer peripheral end surface of the light guide member 150 may be positioned on the outer side relative to the outer surface of the housing 130 in a narrow part (“F2” on the right side as viewed in FIG. 22) of the frame region. Note that a shaded region in FIG. 22 is a region where the light guide member 150 is provided.

(Method for Manufacturing Display Apparatus)

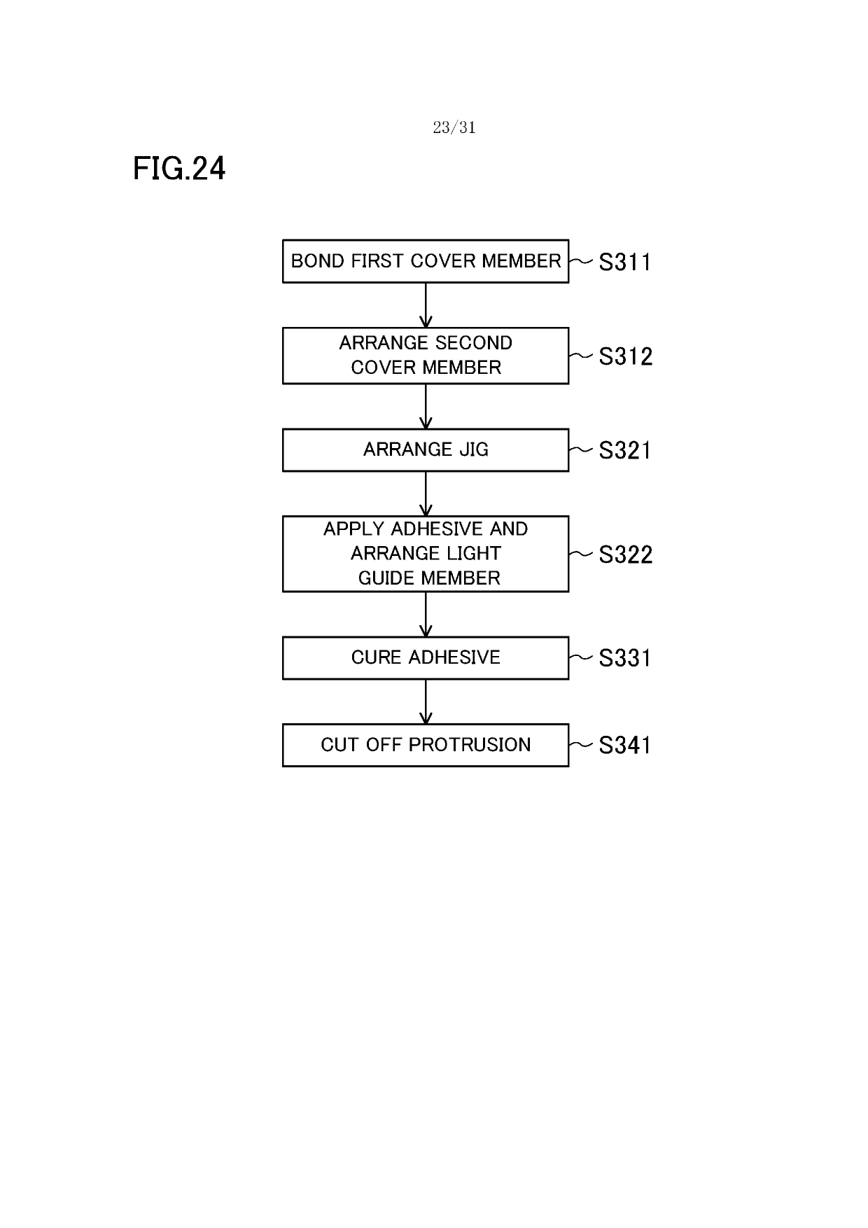

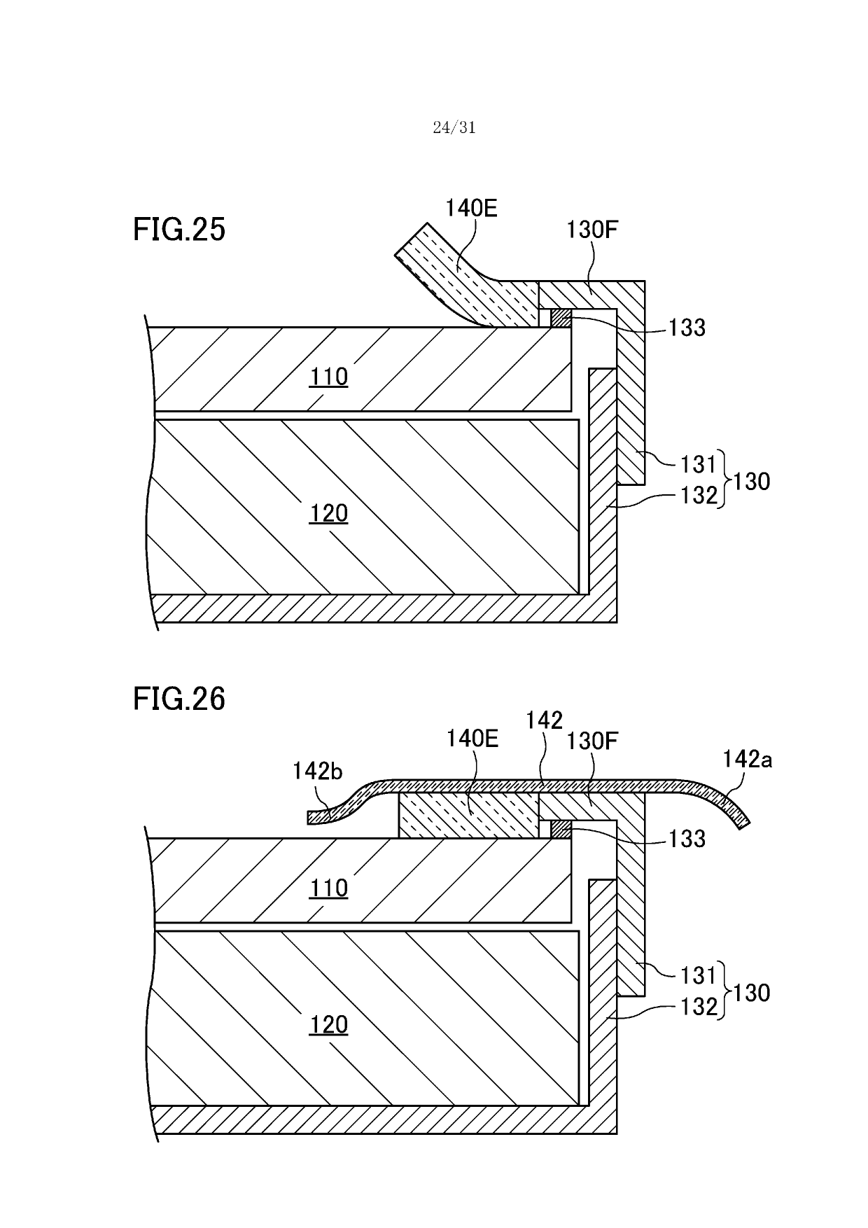

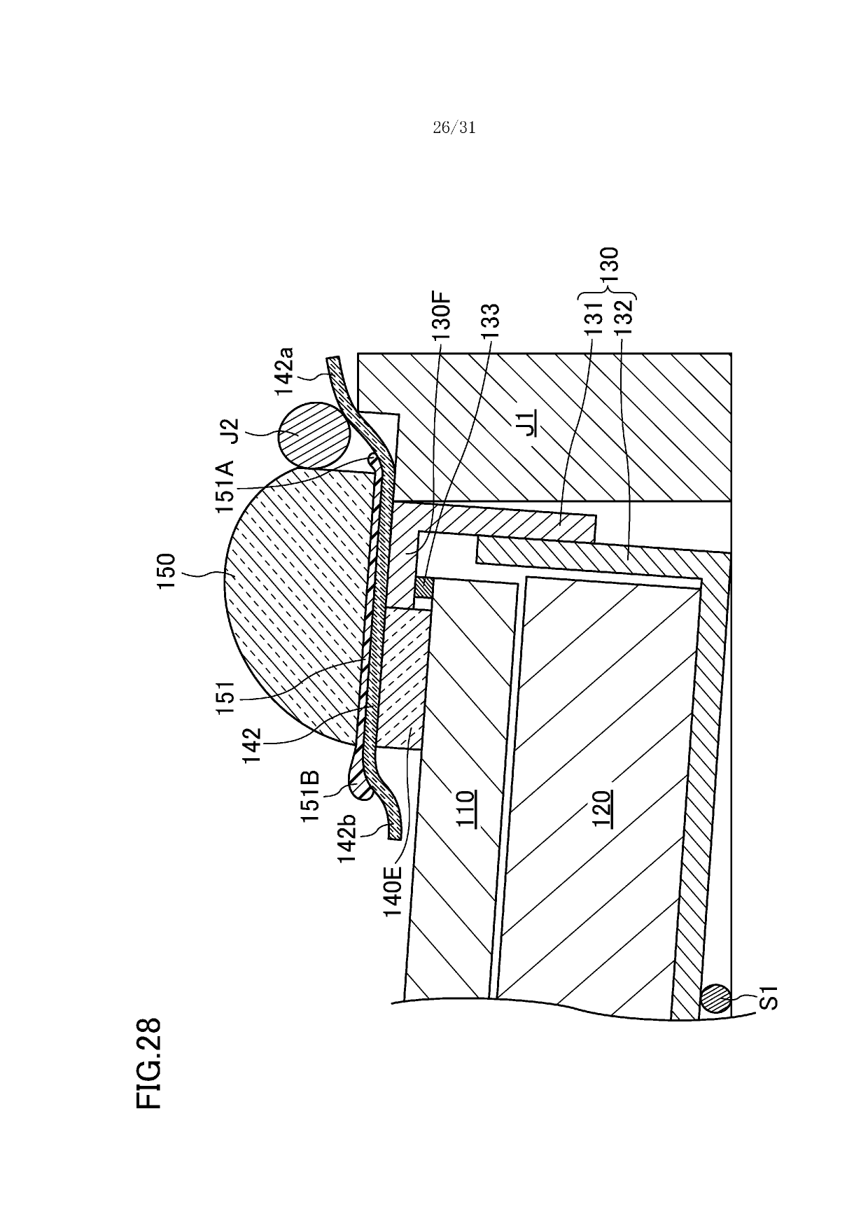

Next, a method for manufacturing the display apparatus 100 having the foregoing configuration will be described. Each of a preparation step, a first step, a second step, a third step, a fourth step, and a fifth step will be described herein with reference to a flowchart illustrated in FIG. 24 and views illustrated in FIGS. 25-30.

Preparation Step

First, a display panel 110, a backlight unit 120, a front housing part 131, a back housing part 132, a protrusion-equipped cover member 142, and a light guide member 150 are prepared. Note that the display panel 110 is formed in a conventionally-known method.

The protrusion-equipped cover member 142 is formed of four elongated PET resin sheets each having a width larger than that of the light guide member 150. Each PET resin sheet is arranged along sides of the display panel 110, and is in a rectangular shape. A region of each PET resin sheet along one of sides of the PET resin sheet extending in a length direction thereof forms an outer protrusion 142a protruding toward the outside of the panel, and a region of the PET resin sheet along the other side of the PET resin sheet extending in the length direction thereof forms an inner protrusion 142b protruding toward the inside of the panel. In the protrusion-equipped cover member 142, the length of the outer protrusion 142a protruding toward the outside of the panel is 1-10 cm. The length of the inner protrusion 142b protruding toward the inside of the panel is 1-10 cm.

First Step

First, the backlight unit 120 is fixed to the back housing part 132. Then, referring to FIG. 7, a frame-shaped spacer 133 is arranged on a surface of a peripheral edge part of the display panel 110 on an image display side 110B or on an inner surface of a flange 130F of the front housing part 131, and the front housing part 131 and the display panel 110 are fixed together at the inner surface of the flange 130F of the front housing part 131 and the surface of the peripheral edge part of the display panel 110 on the image display side 110B. Next, the front housing part 131 and the back housing part 132 are assembled together by, e.g., screw tightening such that an inner side wall surface of the front housing part 131 and an outer side wall surface of the back housing part 132 are supported against each other in contact with each other. Thus, the display panel 110 and the backlight unit 120 are accommodated in the housing 130.

Next, at step S311, a roller is used to bond a first cover member 140E to a surface of the protrusion-equipped cover member 142 close to the display panel 110. In such a state, since the first cover member 140E is made of a transparent elastic material, the first cover member 140E can be curved and bonded such that air bubbles etc. do not enter between the first cover member 140E and the display panel 110. Note that the first cover member 140E is bonded so as to form a frame shape in the state in which an elongated sheet-shaped transparent elastic material is along each of four sides of the display panel 110.

Subsequently, at step S312, the protrusion-equipped cover member 142 is bonded so as to cover the first cover member 140E and the flange 130F of the front housing part 131. Viscosity of the first cover member 140E is used to bond the protrusion-equipped cover member 142 to a surface of the first cover member 140E. In such a state, since a second cover member 140F is formed of a PET resin film, the second cover member 140F can be curved and bonded such that air bubbles etc. do not enter between the first cover member 140E and the second cover member 140F.

Second Step

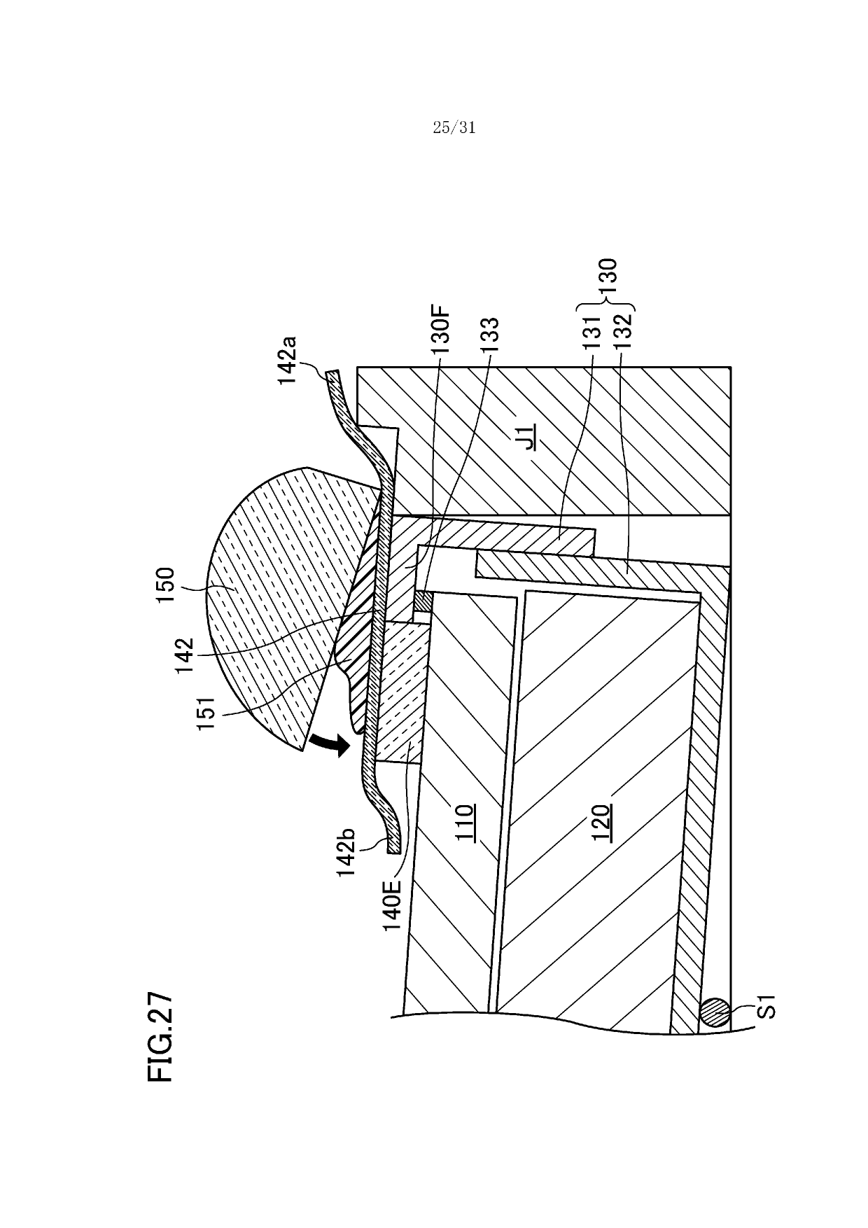

Next, at step S321, a jig J1 and a spacer S1 are arranged to incline a partly-formed display apparatus. The jig J1 is in a housing shape including a part having the same height as that of the flange 130F of the front housing part 131 with the display apparatus being inclined and a step part having a height higher than that of the flange 130F of the front housing part 131 with the display apparatus being inclined. The spacer S1 is arranged below the back housing part 132, and therefore inclines, by using the bottom of the back housing part 132 as a fulcrum, the display apparatus such that the entirety of the display apparatus leans on the jig J1. Referring to FIG. 27, the jig J1 and the spacer S1 are used to arrange the display apparatus with the entirety thereof being inclined.

In such a state, the outer protrusion 142a of the protrusion-equipped cover member 142 is placed on the jig J1, and an outer end of the outer protrusion 142a is placed on the taller step part of the jig J1.

Next, at step S322, an adhesive 151 is applied to a surface of the protrusion-equipped cover member 142. Then, the light guide member 150 is arranged on the adhesive 151. After the light guide member 150 contacts the protrusion-equipped cover member 142 at an outer peripheral end surface of the light guide member 150, an inner peripheral end surface of the light guide member 150 gradually approaches the protrusion-equipped cover member 142 as indicated by an arrow illustrated in FIG. 27. Meanwhile, the adhesive 151 spreads by pressing. When the light guide member 150 is completely arranged on the protrusion-equipped cover member 142, adhesives 151A, 151B spread, by pressing, on the outer protrusion 142a and the inner protrusion 142b. In such a state, since the jig J1 forms an upwardly-extending inclination in the outer protrusion 142a, the adhesive 151A does not spread to the outer side relative to a middle part of the outer protrusion 142a, and does not drop down. When the light guide member 150 is completely arranged on the protrusion-equipped cover member 142, the jigs J1, J2 and the spacer S1 are removed, and the inclined display apparatus returns to the horizontal attitude. Then, alignment of the light guide member 150 is performed by the jig J2, and the light guide member 150 is positioned such that an inner peripheral end surface of the first cover member 140E and the inner peripheral end surface of the light guide member 150 are flush with each other.

Third Step

Next, the adhesive 151B flowing out to the inside of the panel is wiped over. Then, as in the first embodiment, the adhesive 151 interposed between the light guide member 150 and the protrusion-equipped cover member 142 is, at step S331, cured by ultraviolet irradiation and/or heating.

Fourth and Fifth Steps

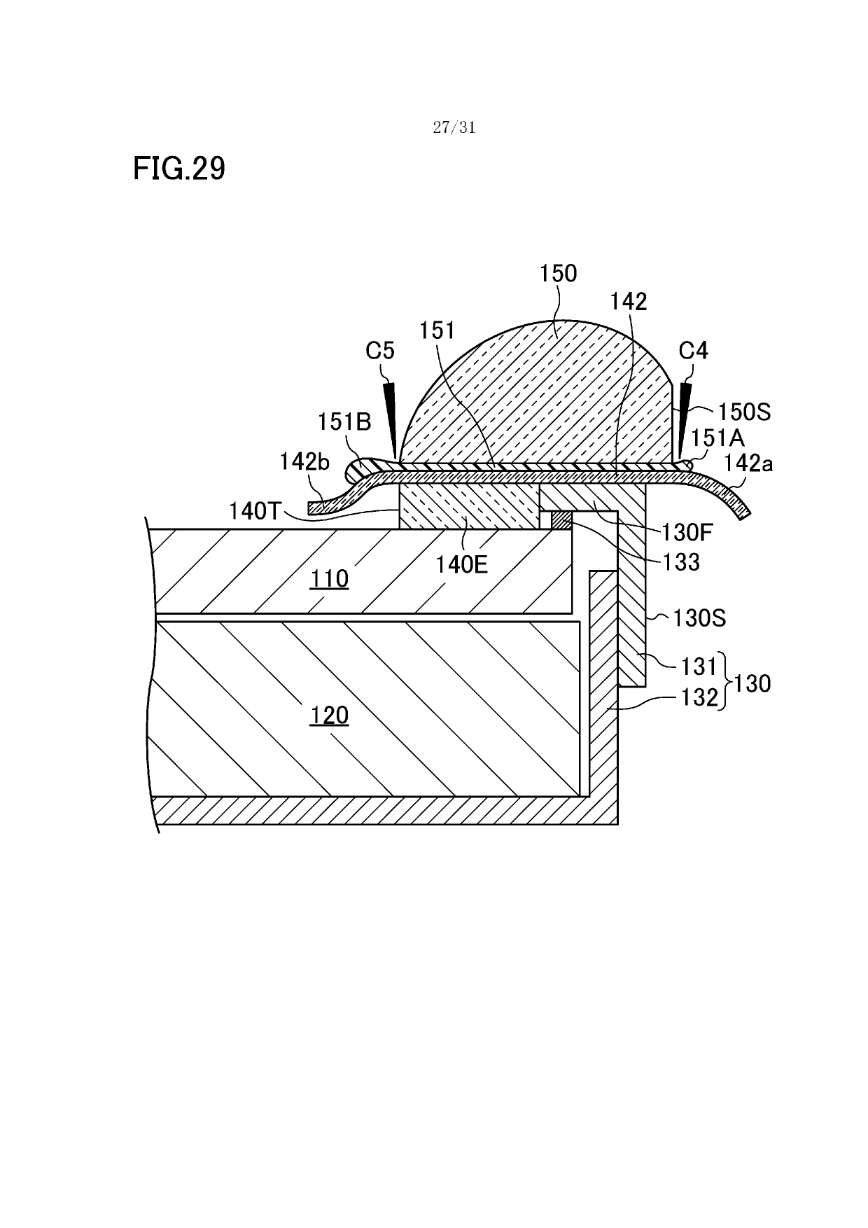

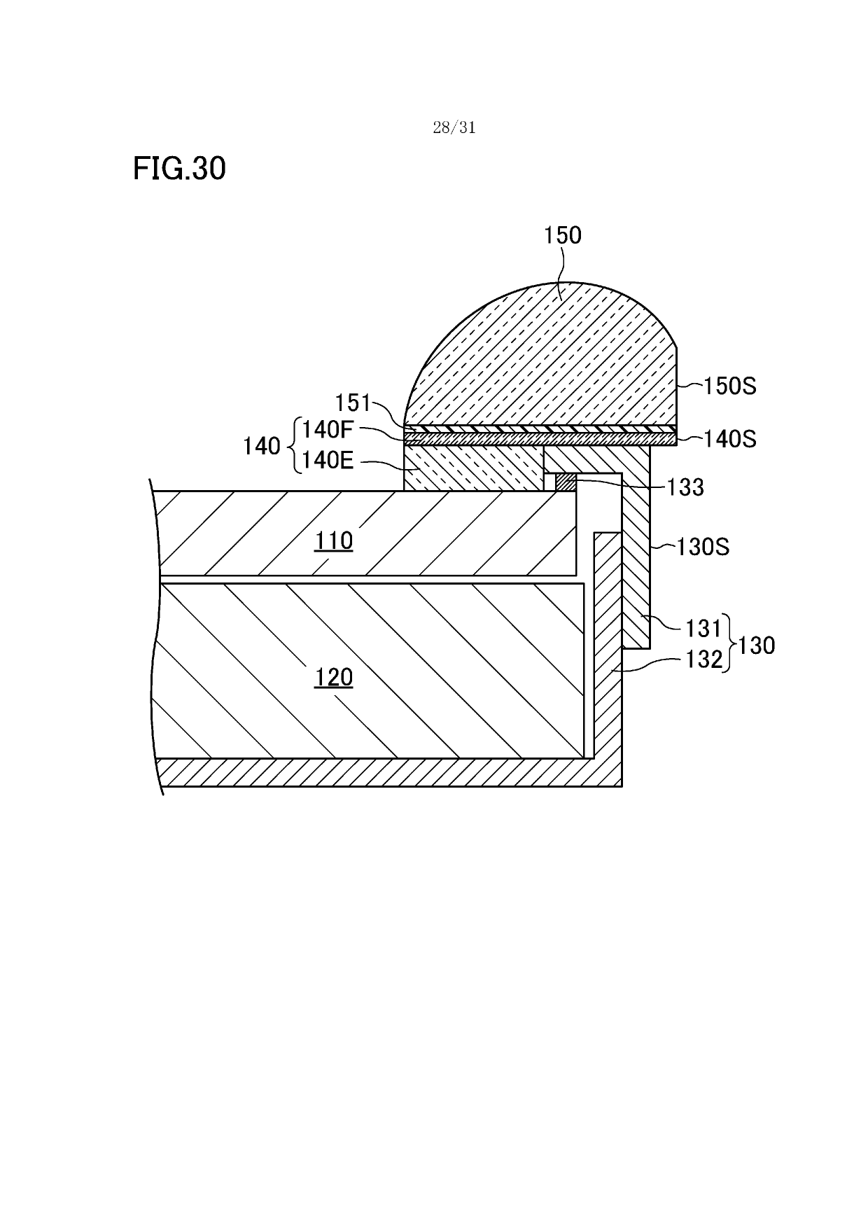

Subsequently, as in the first embodiment, the outer protrusion 142a and the inner protrusion 142b are, at step S341, cut off from the protrusion-equipped cover member 142. The outer protrusion 142a is, by pressing a cutter into a position indicated by “C4” in FIG. 29, cut off such that an outer peripheral end surface 140S of the second cover member 140F and an outer peripheral end surface 150S of the light guide member 150 are flush with each other. Moreover, the inner protrusion 142b is, by pressing the cutter into a position indicated by “C5” in FIG. 29, cut off such that an inner peripheral end surface of the second cover member 140F and an inner peripheral end surface 140T of the first cover member 140E are flush with each other. Since a clearance having a size corresponding to the thickness of the first cover member 140E is formed between the inner protrusion 142b and the display panel 110, the inner protrusion 142b can be cut off without damaging a surface of the display panel 110 when the inner protrusion 142b is cut off. As a result, a display apparatus 100 is formed as illustrated in FIG. 30.

### Advantages of Third Embodiment

According to the third embodiment, since the protrusion-equipped cover member 142 is, at the first step, arranged so as to cover an outer surface of the flange 130F of the housing 130, the adhesive 151 does not drop into the housing 130 even if the adhesive 151 spreads due to the light guide member 150 arranged on a predetermined part of the protrusion-equipped cover member 142 at the second step.

Moreover, according to the third embodiment, the adhesive 151 spreads, at the second step, in such a manner that the light guide member 150 is pressed against adhesive 151 with the display apparatus being inclined, thereby bonding the light guide member 150. Thus, the adhesive 151 does not spread toward the outside of the panel. Since the inner protrusion 142b is provided inside the panel, the adhesive 151B spreading toward the inside of the panel can be easily removed at the same time as removal of the inner protrusion 142b at the fifth step.

### Variations of Third Embodiment

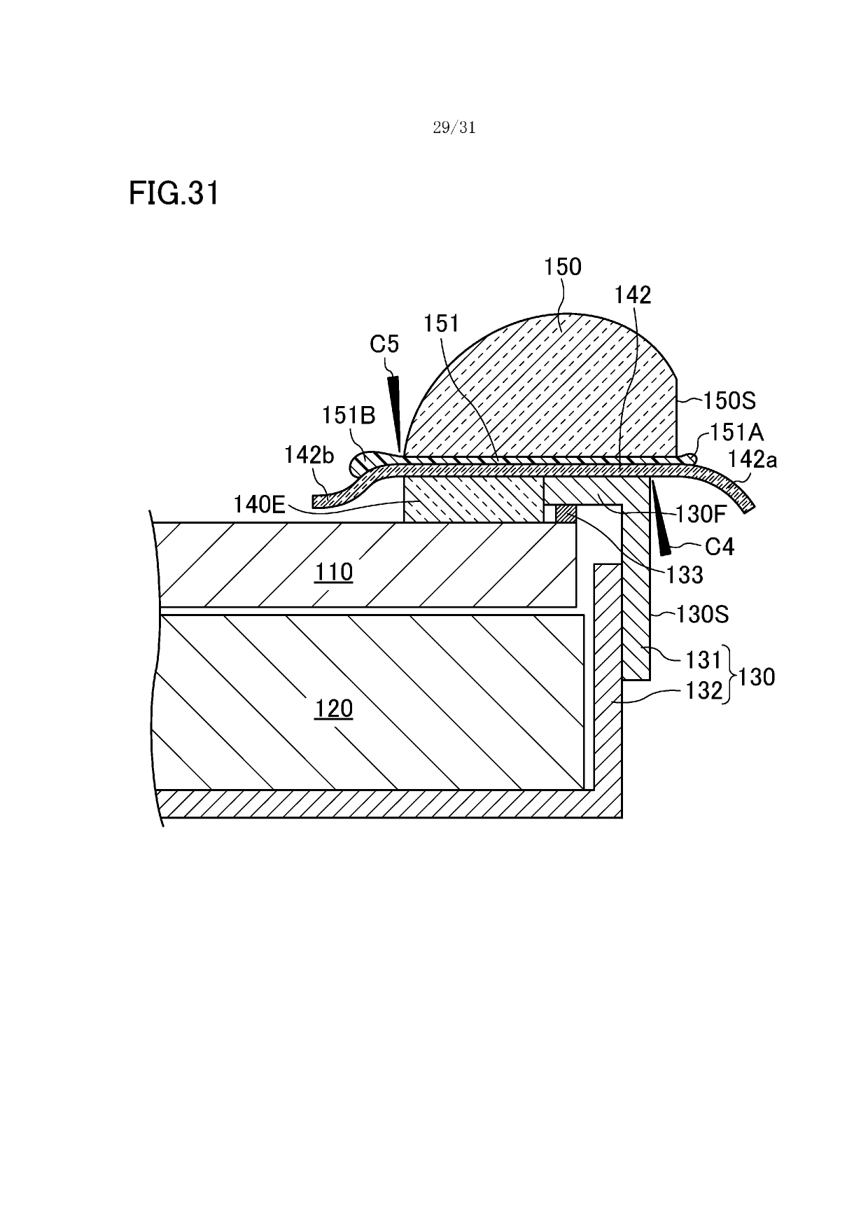

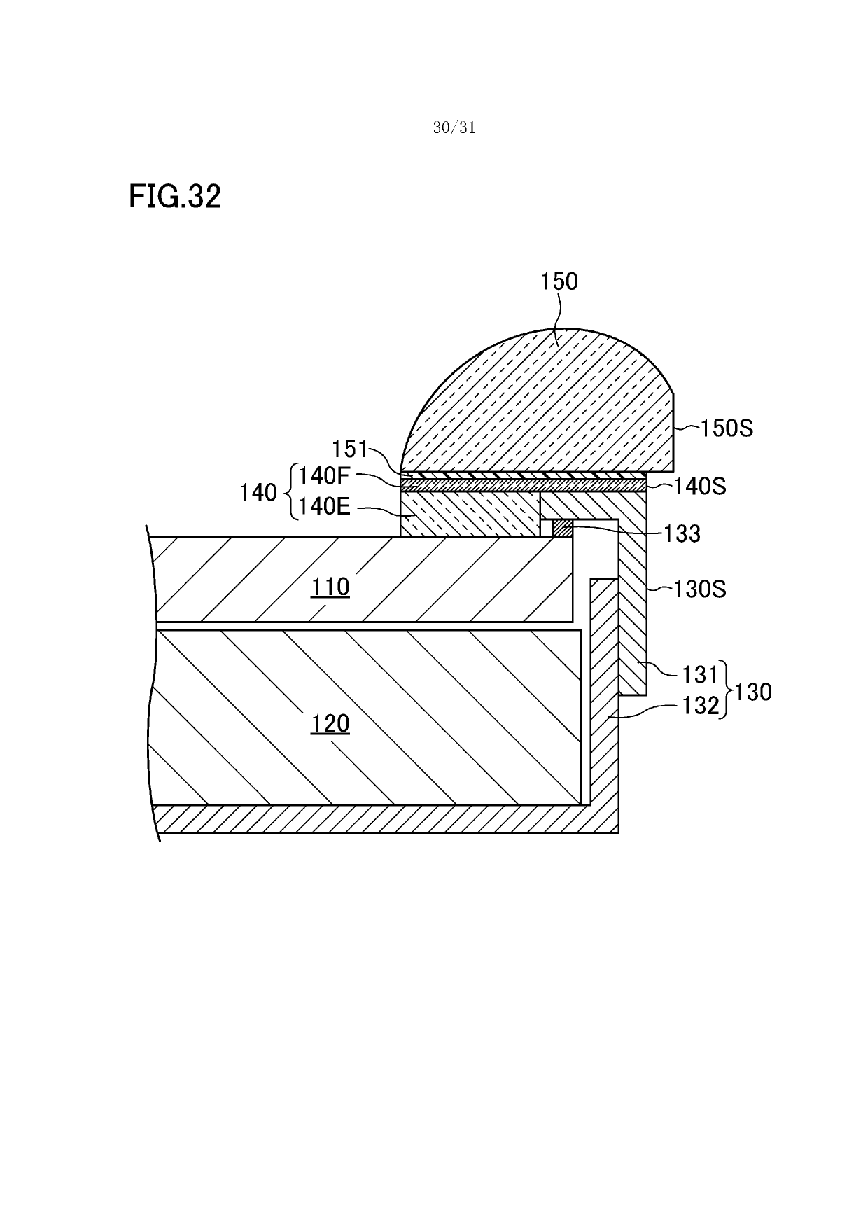

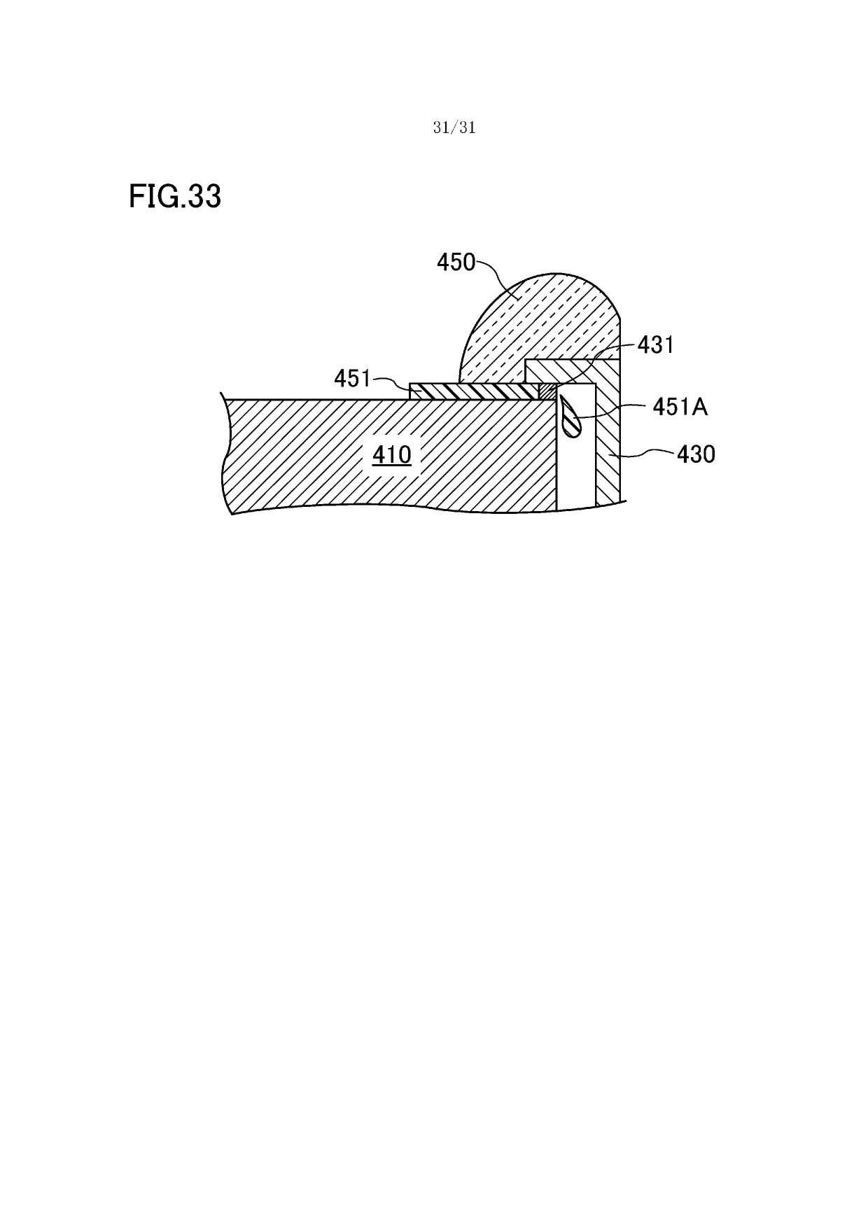

In the third embodiment, it has been described that the outer protrusion 142a is removed relative to the outer peripheral end surface 150S of the light guide member 150 at the fourth step in the method for manufacturing the display apparatus 100. However, as in, e.g., a seventh variation illustrated in FIG. 31, the outer protrusion 142a may be removed relative to the outer surface 130S of the front housing part 131. In such a case, the outer peripheral end surface 140S of the second cover member 140F and the outer surface 130S of the housing 130 are flush with each other as illustrated in FIG. 32.

In the third embodiment, it has been described that the second cover member 140F is formed of the PET resin sheet. However, the second cover member 140F may be formed of a TAC resin sheet, a transparent elastic sheet, or an acrylic resin sheet.

If the second cover member 140F is formed of the TAC resin sheet, the second cover member 140F has flexibility as in the PET resin sheet, and therefore the second cover member 140F can be easily bonded onto the first cover member 140E. Thus, entering of air bubbles etc. between the first cover member 140E and the second cover member 140F is reduced. Moreover, if the second cover member 140F is made of TAC resin, the refractive index of TAC resin is 1.48, and therefore an optical phase difference from the light guide member (having a refractive index of about 1.49) is small. Thus, good visibility can be realized.

If the second cover member 140F is formed of the transparent elastic sheet such as an acrylic gel sheet, a silicone rubber sheet, or a polyurethane sheet, the second cover member 140F has flexibility, and therefore the second cover member 140F can be easily bonded onto the first cover member 140E. Thus, entering of air bubbles etc. between the first cover member 140E and the second cover member 140F can be reduced. Moreover, since the outer protrusion 142a and the inner protrusion 142b are also made of the transparent elastic material, the outer protrusion 142a and the inner protrusion 142b can be easily cut off at the fourth and fifth steps. Further, due to viscosity of the transparent elastic material, dripping of the adhesive 151 applied onto the second cover member 140F is less likely to occur. Still further, due to elasticity of the transparent elastic material, stress applied between the display panel 110 and the light guide member 150 is absorbed, and therefore the panel strength can be enhanced.

If the second cover member 140F is formed of the acrylic resin sheet, excellent chemical resistance and excellent abrasion resistance can be realized.

### Other Embodiments

In the first and second embodiments, it has been described that the adhesive 151 is, at the second step in the method for manufacturing the display apparatus, applied in the state in which the adhesive receiver 170 is placed right below the peripheral end of the protrusion 142a, 143a. However, drops of adhesive 151A may be received by a method other than the method by which the adhesive receiver 170 is placed.

In the first and second embodiments, it has been described that the peripheral end surface 140S of the cover member 140, the outer surface 130S of the front housing part 131, and the outer peripheral end surface 150S of the light guide member 150 are flush with each other. However, the present disclosure is not limited to such a configuration. For example, the outer peripheral end surface 150S of the light guide member 150 may be positioned on the outer side relative to the outer surface 130S of the front housing part 131. In such a case, when the plurality of display apparatuses 100 are combined together to form the multi-display system, adjacent ones of the light guide members 150 of the display apparatuses 100 are combined together without a clearance being formed therebetween, and, on the other hand, a clearance is formed between adjacent ones of the housings 130.

In the sixth variation, it has been described that the arrangement position of the light guide member 150 is determined considering the difference in width of the frame region of the display panel 110 of the display apparatus 100 of the third embodiment according to location. However, in each of the display apparatuses 100 having the configurations of the first and second embodiments, the arrangement position of the light guide member 150 is preferably determined considering the difference in width of the frame region of the display panel 110 according to location.

In the first to third embodiments, it has been described that the frame-shaped light guide member 150 is provided corresponding to the outer peripheral edge part of the housing 130 of the display apparatus 100. However, the light guide member 150 is not necessarily in the frame shape. The light guide member 150 may be provided corresponding to at least part of the outer peripheral edge part of the display apparatus 100 at a boundary between adjacent ones of the display apparatuses in the case where the plurality of display apparatuses 100 are combined together to form the multi-display system 10.

In the foregoing embodiments and variations, the liquid crystal display apparatus has been described as the display apparatus 100. However, the present disclosure is not limited to the liquid crystal display apparatus. For example, the display apparatus 100 may be an organic EL display apparatus, an inorganic EL display apparatus, an electrophoretic display apparatus, a plasma display (PD), a plasma addressed liquid crystal (PALC) display, a field emission display (FED), or a surface-conduction electron-emitter display (SED). Moreover, a drive system of the display panel 110 of the display apparatus 100 may be a field sequential color system.

### INDUSTRIAL APPLICABILITY

The present disclosure is useful for the method for manufacturing the display apparatus, for the display apparatus, and for the multi-display system. More specifically, the present disclosure is useful for the method for manufacturing the display apparatus in which the light guide member is provided at the peripheral edge part of the display apparatus to form the multi-display system configured to display a seamless image, for the display apparatus forming the multi-display system configured to display a seamless image, and to the multi-display system configured to a seamless image.

### DESCRIPTION OF REFERENCE CHARACTERS

10 Multi-Display System
100 Display Apparatus
110 Display Panel
110B Surface on Image Display Side (Surface)
111A, 111B Substrate
113 Liquid Crystal Layer
130 Housing
130F Flange
130S Outer Surface of Housing
131W Window
140 Cover Member
140A First Sheet (First Cover Member)
140B Second Sheet (Second Cover Member)
140C First Cover Part
140D Second Cover Part
140S Peripheral End Surface of Cover Member
142 Protrusion-Equipped Second Sheet (Protrusion-Equipped Cover Member)
142a Protrusion (Outer Protrusion)
142b Inner Protrusion
143 Protrusion-Equipped Cover Member
143a Protrusion
150 Light Guide Member
150S Outer Peripheral End Surface of Light Guide Member
151, 151A, 151B Adhesive
160 Touch Panel Sheet (First Cover Member)
170 Adhesive Receiver

1. A method for manufacturing a display apparatus, comprising:
a first step of arranging a display panel inside a housing which is formed with a window and which includes an inwardly-extending flange forming a window frame surrounding the window, and stacking, on a surface of the display panel, a cover member such that part of the cover member in a thickness direction thereof is fitted into the window and that the remaining part of the cover member in the thickness direction thereof at least partially covers the part of the cover member fitted into the window and an outer surface of the flange;
a second step of arranging, on part of a surface of the cover member corresponding to an outer peripheral edge part of the housing, a light guide member configured to guide light from the display panel to an outside of the display panel with an adhesive being interposed between the cover member and the light guide member; and
a third step of curing the adhesive to bond the light guide member to the cover member.

2. The method of claim 1, wherein
at the first step, the cover member is a protrusion-equipped cover member further including a protrusion protruding outward, and
after the third step, a fourth step of cutting the protrusion off from the protrusion-equipped cover member is performed.

3. The method of claim 1, wherein
the cover member is configured such that a first cover member fitted into the window and a second cover member at least partially covering the first cover member and the outer surface of the flange are stacked on each other.

4. The method of claim 1, wherein
the cover member is integrally formed of a first cover part fitted into the window and a second cover part at least partially covering the first cover part and the outer surface of the flange.

5. The method of claim 1, wherein
at the first step, the cover member is stacked so as to cover at least an entire display region of the display panel.

6. The method of claim 1, wherein
at the first step, the cover member is in a frame shape and is stacked so as to cover a peripheral edge part of the surface of the display panel.

7-15. (canceled)

16. A display apparatus comprising:
a display panel;
a housing which contains the display panel, which is formed with a window, and which includes an inwardly-extending flange forming a window frame surrounding the window;
a transparent cover member stacked on a surface of the display panel such that part of the cover member in a thickness direction thereof is fitted into the window and that the remaining part of the cover member in the thickness direction thereof at least partially covers the part of the cover member fitted into the window and an outer surface of the flange; and
a frame-shaped light guide member bonded to an outer peripheral edge part of the cover member with an adhesive and configured to guide light from the display panel to an outside of the display panel.

17. The display apparatus of claim 16, wherein
the cover member is configured such that a first cover member fitted into the window and a second cover member at least partially covering the first cover member and the outer surface of the flange are stacked on each other.

18. The display apparatus of claim 16, wherein
the cover member is integrally formed of a first cover part fitted into the window and a second cover part covering the first cover part and the outer surface of the flange.

19. The display apparatus of claim 16, wherein
the cover member is bonded so as to cover at least an entire display region of the display panel.

20. The display apparatus of claim 16, wherein
the cover member is in a frame shape and is bonded so as to cover a peripheral edge part of the surface of the display panel.

21. The display apparatus of claim 16, wherein
a peripheral end surface of the cover member is flush with at least one of an outer peripheral end surface of the light guide member or an outer surface of the housing.

22. The display apparatus of claim 20, wherein
the cover member is configured such that the first cover member fitted into the window and the second cover member at least partially covering the first cover member and the outer surface of the flange are stacked on each other, and
an inner peripheral end surface of the second cover member is flush with at least one of an inner peripheral end surface of the first cover member or an inner peripheral end surface of the light guide member.

23. The display apparatus of claim 16, wherein
the cover member is made of acrylic resin.

24. The display apparatus of claim 17, wherein
the first cover member is made of a transparent elastic material.

25. The display apparatus of claim 17, wherein
the second cover member is made of polyethylene terephthalate resin or triacetylcellulose resin.

26. The display apparatus of claim 17, wherein
the second cover member is made of a transparent elastic material.

27. The display apparatus of claim 17, wherein
the second cover member is made of acrylic resin.

28. The display apparatus of claim 16, wherein
the display panel is a liquid crystal display panel in which a liquid crystal layer is provided between two substrates.

29. A multi-display system configured to display an image on a large screen formed by combining a plurality of display apparatuses of claim 16.
